(19) United States
(12) Patent Application Publication
(10) Pub. No.: US 2019/0042915 A1
(43) Pub. Date: Feb. 7, 2019

(54) PROCEDURAL NEURAL NETWORK SYNAPTIC CONNECTION MODES

(71) Applicant: Intel Corporation, Santa Clara, CA (US)

(72) Inventors: Berkin Akin, Hillsboro, OR (US); Seth Pugsley, Hillsboro, OR (US)

(21) Appl. No.: 15/941,621

(22) Filed: Mar. 30, 2018

(51) Int. Cl. G06N 3/04; G06N 3/063; G06N 3/08

(52) U.S. Cl. CPC G06N 3/049; G06N 3/08; G06N 3/0635

(57) ABSTRACT

Systems and techniques for procedural neural network synaptic connection modes are described herein. A synapse list header may be loaded based on a received spike indication. A spike target generator may then execute a generator function identified in the synapse list header to produce a spike message. Here, the generator function accepts a current synapse value as input to produce the spike message. The spike message may then be communicated a neuron.

### TECHNICAL FIELD

The present disclosure relates generally to electronic hardware including neuromorphic hardware, and more specifically to procedural neural network synaptic connection modes.

### BACKGROUND

A neuromorphic processor is a processor that is structured to mimic certain aspects of the brain and its underlying architecture, particularly its neurons and the interconnections between the neurons, although such a processor may deviate from its biological counterpart. A neuromorphic processor may be composed of many neuromorphic cores that are interconnected via a network architecture, such as a bus or routing devices, to direct communications between the cores. The network of cores may communicate via short packetized spike messages sent from core to core. Each core may implement some number of primitive nonlinear temporal computing elements (e.g., neurons). When a neuron's activation exceeds some threshold level, it may generate a spike message that is propagated to a set of fan-out neurons contained in destination cores. The network then may distribute the spike messages to destination neurons and, in turn, those neurons update their activations in a transient, time-dependent manner. Artificial neural networks (ANNs) that operate via spikes may be called spiking neural networks (SNNs).

SNNs may use spike time dependent plasticity (STDP) to train. STDP updates synaptic weights—a value that modifies spikes received at the synapse to have more or less impact on neuron activation than the spike alone—based on when, in relation to neuron activation (e.g., an outbound spike) an incoming spike is received. Generally, the closer to the outbound spike that the inbound spike is received, the greater the corresponding synapse weight is modified. If the inbound spike precedes the outbound spike, the weight is modified to cause a future spike at that synapse to be more likely to cause a subsequent outbound spike. If the inbound spike follows the outbound spike, the corresponding synapse weight is modified to cause a future spike at the synapse to be less likely to cause a subsequent outbound spike. These relationships dampen noise (e.g., incoming spikes that follow the outbound spike had no part in creating the outbound spike and may be considered noise) while reinforcing pattern participants.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example diagram of a simplified neural network, according to an embodiment.

FIG. 2 illustrates a high-level diagram of a model neural-core structure, according to an embodiment.

FIG. 3 illustrates an overview of a neuromorphic architecture design for a spiking neural network, according to an embodiment.

FIG. 4A illustrates a configuration of a Neuron Processor Cluster for use in a neuromorphic hardware configuration, according to an embodiment.

FIG. 4B illustrates a configuration of an Axon Processor for use in a neuromorphic hardware configuration, according to an embodiment.

FIG. 5 illustrates a system-level view of the neuromorphic hardware configuration of FIGS. 3 to 4B, according to an embodiment.

FIG. 6 is a block diagram that illustrates an example of a spike target generator (STG) to implement an aspect of procedural neural network synaptic connection modes, according to an embodiment.

FIG. 7 illustrates examples of memory arrangements for spike target data, according to an embodiment.

FIG. 8 illustrates an example of a memory arrangement for dislocated synapse list headers (SLHs) and synapse data, according to an embodiment.

FIG. 9 illustrates a flow chart of an example of a method for neuromorphic hardware multitasking, according to an embodiment.

FIG. 10 is a block diagram illustrating an example of a machine upon which one or more embodiments may be implemented.

FIG. 11 is a block diagram of a register architecture according an embodiment.

FIG. 12 is a block diagram illustrating both an example in-order pipeline and an example register renaming, out-of-order issue/execution pipeline according to various embodiments.

FIG. 13 is a block diagram illustrating both an example embodiment of an in-order architecture core and an example register renaming, out-of-order issue/execution architecture core to be included in a processor according to various embodiments.

FIGS. 14A-14B illustrate a block diagram of a more specific example in-order core architecture, which core would be one of several logic blocks (including other cores of the same type and/or different types) in a chip.

FIG. 15 is a block diagram of a processor that may have more than one core, may have an integrated memory controller, and may have integrated graphics according to various embodiments.

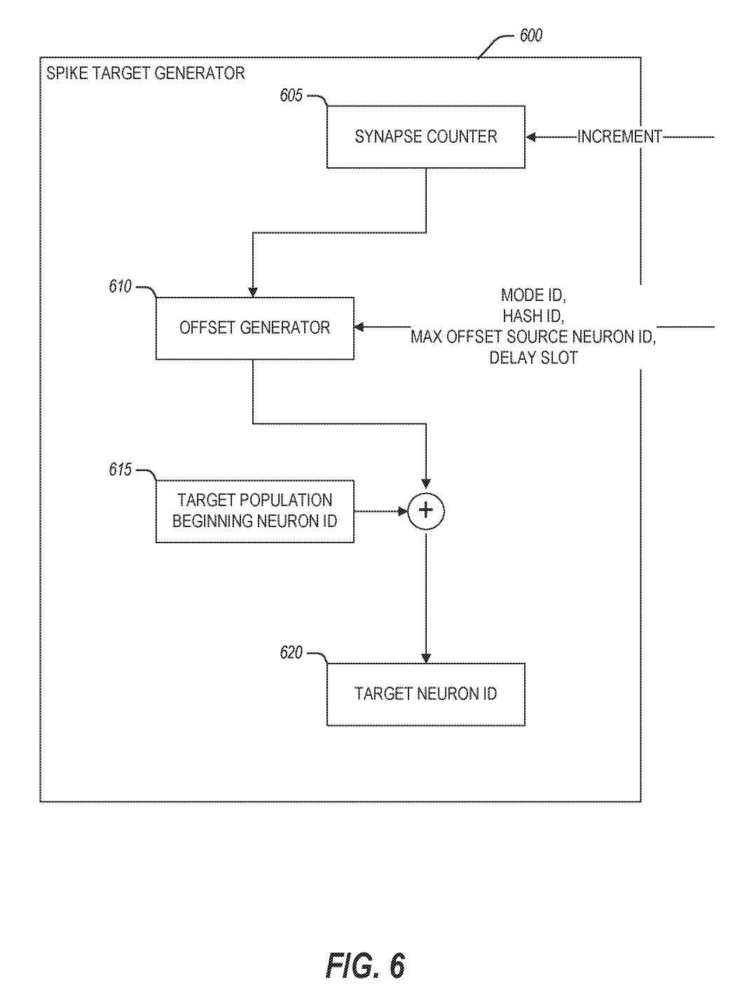

FIGS. 6-19 are block diagrams of example computer architectures.

FIG. 20 is a block diagram contrasting the use of a software instruction converter to convert binary instructions in a source instruction set to binary instructions in a target instruction set according to various embodiments.

### DETAILED DESCRIPTION

Neuromorphic accelerators (e.g., neuromorphic processors or processing clusters) may be organized in a number of ways to approach the speed and connectivity of biological neural networks. Efficiently packing millions of neurons and billions of inter-neuron connections in hardware may be difficult. Embodiments detailed herein describe a neuromorphic architecture that uses external memory resources in the processing operations of a neuromorphic architecture. As a result, the creation of a very large neural network, even into multi-millions or multi-billions of neurons, may be launched and utilized with use of a single accelerator chip. This is possible because the present approaches enable a “fanned-out” rather than a “fanned-in” neuromorphic accelerator architecture, to allow the many synapse states associated with the various neurons to be distributed to external memory. Additionally, aspects of spatial locality associated with synapses may be exploited in the present approaches by storing information from such synapses in an organized form in the external memory (e.g., in contiguous memory locations).

An SNN, in its basic form, resembles a graph with nodes and edges. In an SNN, the nodes are called neurons, and the edges between neurons are called synapses. A neuron is adapted to perform two functions: accumulate “membrane potential” and “spike.” The membrane potential (also referred to as simply “potential”) may resemble an accumulating counter, such that when the potential becomes high enough, the neuron spikes. This spiking neuron is commonly referred to as a “presynaptic neuron.” When the presynaptic neuron spikes, it sends out spike messages along all of the presynaptic neuron's outgoing connections to all target neurons of the presynaptic neuron, called “postsynaptic neurons.” Each of these messages has a “weight” associated with it, and these weights may be positive or negative, increasing or decreasing the postsynaptic neuron's potential. Additionally, time is an important aspect of SNNs, and some spike messages may take longer to arrive at the postsynaptic neuron than others, even if they were sent from the presynaptic neuron at the same time.

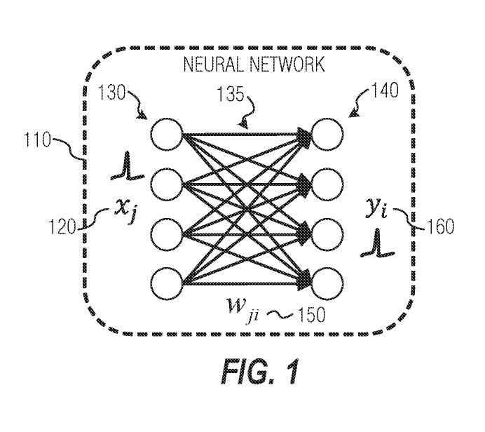

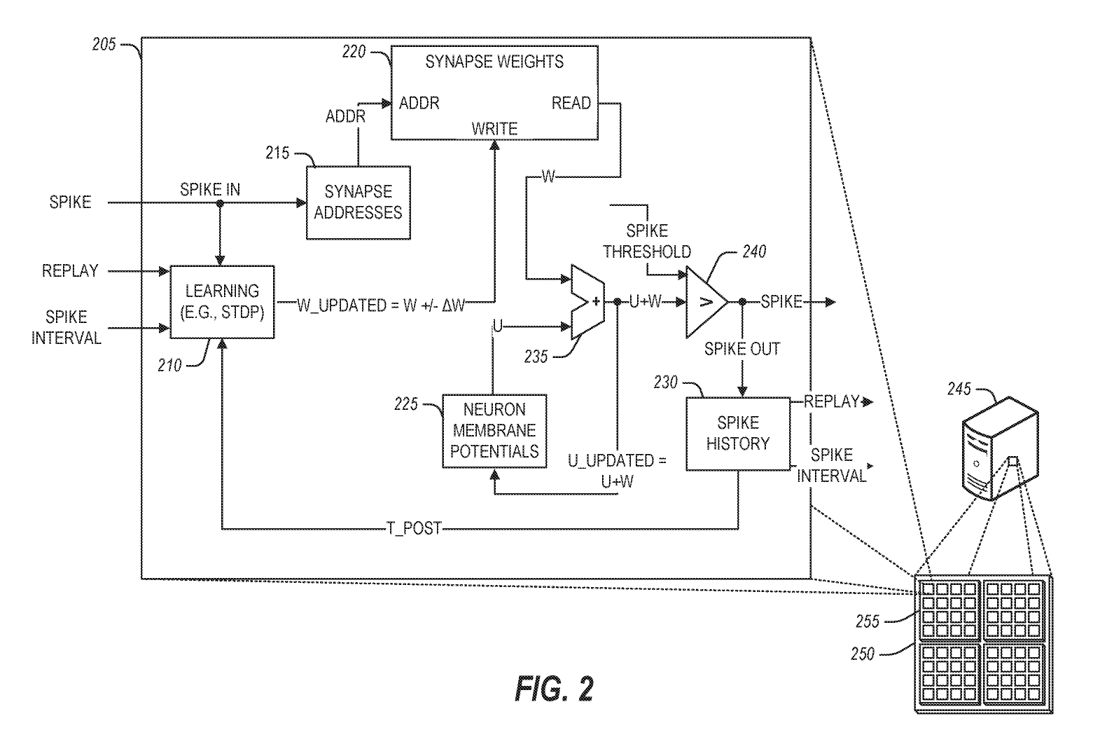

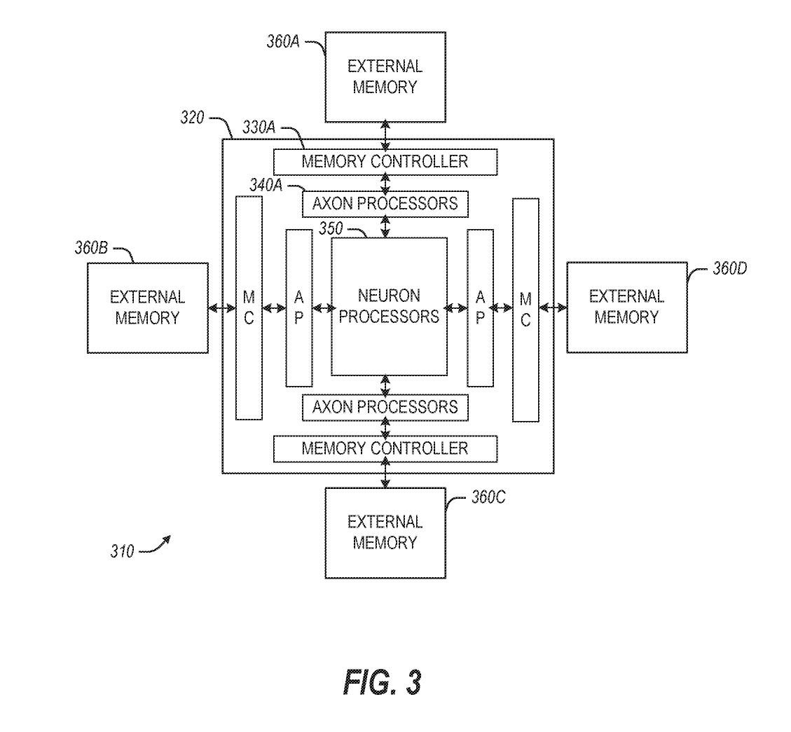

The following configurations, specifically as detailed in FIGS. 3 to 5, provide a configuration of an accelerator chip for implementing an SNN that stores synaptic data with external memory. The context in which an SNN operates, and an overall architecture of an SNN as implemented in neuromorphic hardware, is provided in FIGS. 1 and 2 and discussed in the following paragraphs. Also, as used herein, references to “neural network” for at least some examples is specifically meant to refer to an SNN; thus, many references herein to a “neuron” are meant to refer to an artificial neuron in an SNN. It will be understood, however, that certain of the following examples and configurations may also apply to other forms or variations of artificial neural networks.

As noted above, biological-scale spiking neural networks involve simulating very large number of neurons (e.g., several million neurons) and orders of magnitude more synapses (e.g., several billion synapse) modeling connections between the neurons. Often, the state corresponding to the synapse data occupies a large memory footprint that may be, for example, off-chip (e.g., connected to processing circuitry via an interconnect). Synapse state conventionally includes a source, a target neuron ID, or both, as well as a synaptic connection weight between them. Generally the synapse weight is represented with a low precision value (e.g., 8-bits or 16-bits). However, as the neural network size increase, the number of bits to uniquely address the neurons also grows, and may become quite large. For example, 24-bits may be used to address 16 million neurons.

Procedural neural network synaptic connection modes may be used to address the issues surrounding increasing storage corresponding to ever larger neural networks by replacing some or all of the synapse data with procedurally generated data. This then compresses synapse state for neural network accelerators. Procedural neural network synaptic connection modes are enabled by a design practice in which structured synaptic connection schemes between neuron populations are used when developing neural network (e.g., SNN) models. For several types of these structured connections, connectivity information may be represented in a procedural representation between neuron populations that are herein referred to as connection modes. By using these modes, individual neuron IDs in the synapse state, for example, may be generated by the hardware processing neuron activity (e.g., spike messages, updating neuron state, etc.). This not only reduces the amount of data that is stored in external memory, but also decreases latency due to the often comparatively slow memory accesses used to retrieve that data. Additional details and examples are described below.

FIG. 1 illustrates an example diagram of a simplified neural network 110, providing an illustration of connections 135 between a first set of nodes 130 (e.g., neurons) and a second set of nodes 140 (e.g., neurons). Neural networks (such as the simplified neural network 110) are commonly organized into multiple layers, including input layers and output layers. It will be understood that the simplified neural network 110 only depicts two layers and a small numbers of nodes, but other forms of neural networks may include a large number of nodes, layers, connections, and pathways.

Data that is provided into the neural network 110 is first processed by synapses of input neurons. Interactions between the inputs, the neuron's synapses, and the neuron itself govern whether an output is provided to another neuron. Modeling the synapses, neurons, axons, etc., may be accomplished in a variety of ways. In an example, neuromorphic hardware includes individual processing elements in a synthetic neuron (e.g., neurocore) and a messaging fabric to communicate outputs to other neurons. The determination of whether a particular neuron “fires” to provide data to a further connected neuron is dependent on the activation function applied by the neuron and the weight of the synaptic connection (e.g., wᵢⱼ 150) from neuron (e.g., located in a layer of the first set of nodes 130) to neuron i (e.g., located in a layer of the second set of nodes 140). The input received by neuron j is depicted as value xⱼ 120, and the output produced from neuron i is depicted as value yⱼ 160. Thus, the processing conducted in a neural network is based on weighted connections, thresholds, and evaluations performed among the neurons, synapses, and other elements of the neural network.

In an example, the neural network 110 is established from a network of SNN cores, with the neural network cores communicating via short packetized spike messages sent from core to core. For example, each neural network core may implement some number of primitive nonlinear temporal computing elements as neurons, so that when a neuron's activation exceeds solve threshold level, it generates a spike message that is propagated to a fixed set of fanout neurons contained in destination cores. The network may distribute the spike messages to all destination neurons, and in response those neurons update their activations in a transient, time-dependent manner, similar to the operation of real biological neurons.

The neural network 110 further shows the receipt of a spike, represented in the value xⱼ 120, at neuron j in a first set of neurons (e.g., a neuron of the first set of nodes 130). The output of the neural network 110 is also shown as a spike, represented by the value yᵢ 160, which arrives at neuron i in a second set of neurons (e.g., a neuron of the first set of nodes 140) via a path established by the connections 135. In a spiking neural network all communication occurs over event-driven action potentials, or spikes. In an example, the spikes convey no information other than the spike time as well as a source and destination neuron pair. Computation occurs in each neuron as a result of the dynamic, nonlinear integration of weighted spike input using real-valued state variables. The temporal sequence of spikes generated by or for a particular neuron may be referred to as its “spike train.”

In an example of an SNN, activation functions occur via spike trains, which means that time is a factor that has to be considered. Further, in an SNN, each neuron may be modeled after a biological neuron, as the artificial neuron may receive its inputs via synaptic connections to one or more “dendrites” (part of the physical structure of a biological neuron), and the inputs affect an internal membrane potential of the artificial neuron “soma” (cell body). As previously discussed, in an SNN, the artificial neuron “fires” (e.g., produces an output spike), when its membrane potential crosses a firing threshold. Thus, the effect of inputs on an SNN neuron operates to increase or decrease the internal membrane potential, making the neuron more or less likely to fire. Further, in an SNN, input connections may be stimulatory or inhibitory. A neuron's membrane potential may also be affected by changes in the neuron's own internal state (“leakage”).

In some examples, the neural network may utilize spikes in a neural network pathway to implement learning using a learning technique such as spike tinning dependent plasticity (STDP). For instance, a neural network pathway may utilize one or more inputs (e.g., a spike or spike train) being provided to a presynaptic neuron X_{PRE} for processing; the neuron X_{PRE} causes a first spike, which is propagated to a neuron X_{POST} for processing; the connection between the neuron X_{PRE} and the postsynaptic neuron X_{POST} (e.g., a synaptic connection) is weighted based on a weight. If inputs received at neuron X_{POST} (e.g., received from one or multiple connections) reach a particular threshold, the neuron X_{POST} will activate (e.g., “fire”), causing a second spike.

The determination that the second spike is caused as a result of the first spike may be used to strengthen the connection between the neuron X_{PRE}, and the neuron X_{POST} (e.g., by modifying a weight) based on principles of STDP. Specifically, STDP may be used to adjust the strength of the connections (e.g., synapses) between neurons in a neural network, by correlating the timing between an input spike (e.g., the first spike) and an output spike (e.g., the second spike). In further examples, the weight may be adjusted as a result of long-term potentiation (LTP), long term depression (LTD), or other techniques. A neural network pathway, when combined with other neurons operating on the same principles, may exhibit natural unsupervised learning as repeated patterns in the inputs will have pathways strengthened over tune. Conversely, noise, which may produce the spike on occasion, will not be regular enough to have associated pathways strengthened.

FIG. 2 illustrates a high-level diagram of a model neural-core structure, according to an embodiment. The following neural-core structure may implement additional techniques and configurations, such as is discussed below for SNN multitasking and SNN cloning. Thus, the diagram of FIG. 2 is provided as a simplified example of how neuromorphic hardware operations may be performed.

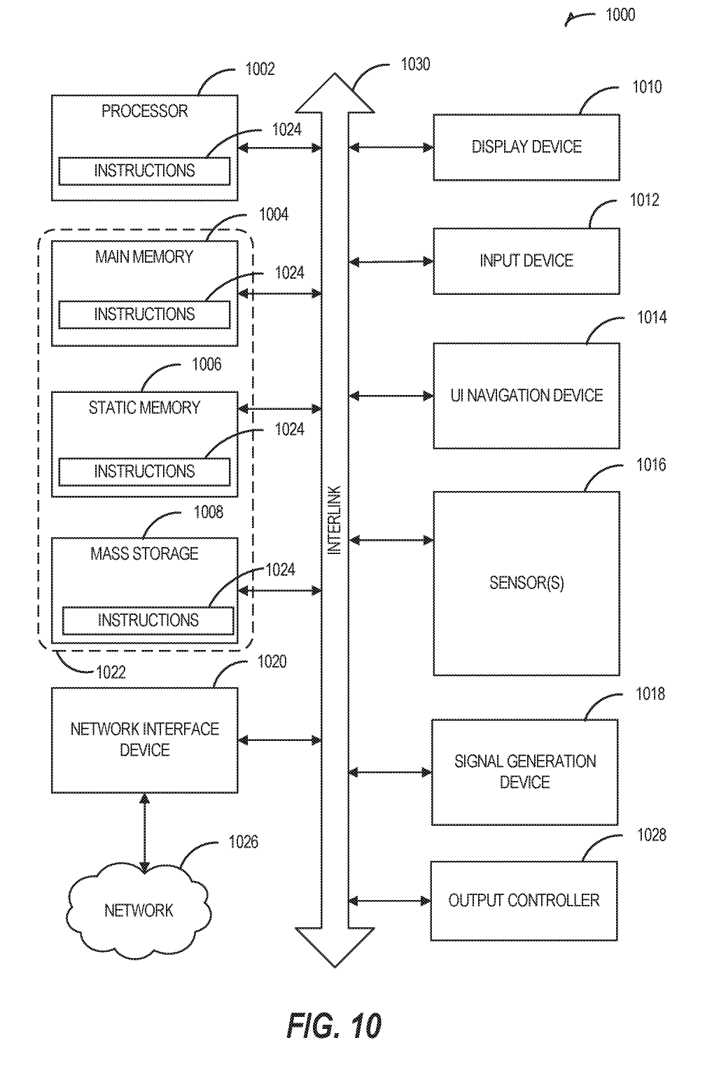

In an example, a neural-core 205 may be on a die with several other neural-cores to form a neural-chip 255. Several neural-chips 255 may be packaged and networked together to form neuromorphic hardware 250, which may be included in any number of devices 245, such as servers, mobile devices, sensors, actuators, etc. The neuromorphic hardware 250 may be a primary processor of these devices (e.g., processor 1002 described below with respect to FIG. 10), or may be a co-processor or accelerator that compliments another processor of these devices. The illustrated neural-core structure functionally models the behavior of a biological neuron in the manner described above. A signal is provided at an input (e.g., ingress spikes, spike in, etc.) to a synapse (e.g., modeled by synapse weights 220 in a synaptic variable memory) that may result in fan-out connections within the core 205 to other dendrite structures with appropriate weight and delay offsets (e.g., represented by the synapse addresses 215 to identify to which synapse a dendrite corresponds). The signal may be modified by the synaptic variable memory (e.g., as synaptic weights are applied to spikes addressing respective synapses) and made available to the neuron model. For instance, the combination of the neuron membrane potentials 225 may be multiplexed 235 with the weighted spike and compared 240 to the neuron's potential to produce an output spike (e.g., egress spikes via an axon to one or several destination cores) based on weighted spike states.

In an example, a neuromorphic computing system may employ learning 210 such as with the previously described STDP techniques. For instance, a network of neural network cores may communicate via short packetized spike messages sent from core to core. Each core may implement some number of neurons, which operate as primitive nonlinear temporal computing elements. When a neuron's activation exceeds some threshold level, the neuron generates a spike message that is propagated to a set of fan-out neurons contained in destination cores. In managing its activation level, a neuron may modify itself (e.g., modify synapse weights 220) in response to a spike. These operations may model a number of time-dependent features. For example, following a spike, the impact of PRE spike may decay in an exponential manner. This exponential decay, modeled as an exponential function, may continue for a number of time steps, during which additional spikes may or may not arrive.

The neural-core 205 may include a memory block that is adapted to store the synapse weights 220, a memory block for neuron membrane potentials 225, integration logic 235, thresholding logic 240, on-line learning and weight update logic based on STDP 210, and a spike history buffer 230. With the techniques discussed herein (e.g., with reference to FIGS. 3 to 5, below), the synapse weights 220 and membrane potentials 225 may be divided between on-chip neuron state data (e.g., stored in internal SRAM) and off-chip synapse data (e.g., stored in DRAM).

In a specific implementation, when a spike from a presynaptic neuron received, the synaptic weight is accessed and is added to the postsynaptic neuron's membrane potential (u). An outgoing spike is generated if the updated (u) is larger than a pre-set spike threshold. The outgoing spike resets a spike history buffer, which counts how many time-steps have passed since the last time each neuron in the core has spiked (t_{POST}). In a further example, the neural-core may implement variations of on-line (e.g., in chip) learning operations performed in the proposed core, such as LTD, single PRE spike LTP, or multiple PRE spike LTP.

The new synaptic weights, as computed by Δw, are installed in the synaptic memory 220 to modify (e.g., weight) future PRE spikes, thus modifying the likelihood that a particular combination of PRE spikes causes a POST spike. The network distributes the spike messages to destination neurons and, in response to receiving a spike message, those neurons update their activations in a transient, time-dependent manner, similar to the operation of biological neurons.

The basic implementation of some applicable learning algorithms in the neural-core 205 may be provided through STDP, which adjusts the strength of connections (e.g., synapses) between neurons in a neural network based on correlating the timing between an input (e.g., ingress) spike and an output (e.g., egress) spike. Input spikes that closely precede an output spike for a neuron are considered causal to the output and their weights are strengthened, while the weights of other input spikes are weakened. These techniques use spike times, or modeled spike times, to allow a modeled neural network's operation to be modified according to a number of machine learning modes, such as in an unsupervised learning mode or in a reinforced learning mode.

In further example, the neural-core 205 may be adapted to support backwards-propagation processing. In biology, when the soma spikes (e.g., an egress spike), in addition to that spike propagating downstream to other neurons, the spike also propagates backwards down through a dendritic tree, which is beneficial for learning. The synaptic plasticity at the synapses is a function of when the postsynaptic neuron fires and when the presynaptic neuron is firing the synapse knows when the neuron is fired. Thus, in a multi-compartment architecture, once the soma fires, there are other elements that know that the neuron fired in order to support learning, e.g., so all of the input fan-in synapses may see that the neuron fired. The learning component 210 may implement STDP and receive this backwards action potential (bAP) notification (e.g., via trace computation circuitry) and communicate with and adjust the synapses accordingly. However it will be understood that changes to the operational aspects of the neural-core 205 may vary significantly, based on the type of learning, reinforcement, and spike processing techniques used in the type and implementation of neuromorphic hardware.

FIG. 3 illustrates an overview of a neuromorphic architecture 310 for a spiking neural network. Specifically, the architecture depicts an accelerator chip 320 arranged for storing and retrieving synaptic data of neural network operations in external memory.

The accelerator chip 320 is arranged to include three types of components: Neuron Processors 350, Axon Processors (APs) 340 (e.g., a first set of axon processors 340A), and Memory Controllers (MCs) 330 (e.g., a first memory controller 330A), in addition to necessary interconnections among these components (e.g., a bus). In the architecture 310, the work of processing functions of the SNN is configured to be divided between the Neuron Processors 350 and the Axon Processors 340 with the following configurations.

In an example, each Axon Processor 340 is arranged to be tightly coupled to one physical channel of external memory 360 (e.g., as indicated with respective sets of memory 360A, 360B, 360C, 360D), with the respective Axon Processor 340 being in charge of processing the spikes whose synapse data resides in that channel of memory. The external memory 360 may constitute respective sets or arrangements of high-performance DRAM (e.g., High Bandwidth Memory (HBM) standard DRAM, Hybrid Memory Cube (HMC) standard DRAM, etc.); in other examples, the external memory 360 may constitute other forms of slower but denser memory (including stacked phase-change memory (e.g., implementing the 3D XPoint standard), DDRx-SDRAM, GDDRx SDRAM, LPDDR SDRAM, direct through-silicon via (TSV) die-stacked DRAM, and the like).

In addition to the processing being split between multiple components in the accelerator chip 320, the storage of the various SNN states is also divided. Neuron state is stored on-chip adjacent to the Neuron Processors 350, such as in an on-chip SR AM implementation (not shown); synapse data, however, is stored in external memory 360. This division is performed for two primary reasons: the size of the data, and the locality of the data.

Synapse data takes up orders of magnitude more memory space than neuron state data. Also, the synapse data is accessed with high spatial locality, but no temporal locality, whereas the neuron data is accessed with no spatial locality, but high temporal locality. Further, there is a strong notion of time in SNNs, and some spike messages take more time to generate and propagate than others. In the SNN accelerator 310, similar to conventional SNN accelerator designs, time is broken up into discrete, logical “time steps.” During each time step, some spike messages will reach their target, and some neurons may spike. These logical time steps each take many accelerator clock cycles to process. Storage of the synapse data may be appropriate in the external memory 360 during relatively large amounts of time where such data is not being used.

A significant neuromorphic processing problem solved with the configuration of the SNN accelerator 310, however, is the balance of network size and programmability. In some SRAM-based SNN accelerators, in order to achieve even moderate neural network sizes, constraints are placed on the connections that may and cannot be made between neurons (i.e., synapse programmability). These constraints may take the form of synapse sharing between neurons, limited connectivity matrices, or restrictive compression demands. In other words, each neuron is prevented from having a unique set of synapses connecting the neuron to a set of arbitrary target neurons. The increased capacity of external memory banks allows for the flexibility of far greater expansions to the SNN, where each synapse is defined by a unique <target, weight> pair. However, the same techniques used for managing synapses and neuron states in SRAM-based SNN accelerators may be used within the SNN accelerator 310, further multiplying the already very large effective capacity that the SNN accelerator 310 provides with the external memory 360.

In the external memory 360, each neuron may have a corresponding data structure for a list of synapses. The data structure may include a target synapse, weight, or delay specification given a source neuron. The delay (also referred to as a “delay slot”) is a time step after the spike to deliver the spike to the destination neuron corresponding to the synapse. In an example, all of the synapses that will “arrive” at their postsynaptic neuron at the same time are stored in memory next to each other. For instance, the synaptic data may be stored in contiguous or consecutive memory blocks, or in locations in the memory that allow writing or reading to occur with a reduced number of operations or amount of time. In an example, during each given time step of the neural network, all of the synapses of a presynaptic neuron that will arrive during that time step are fetched from the external memory 360; whereas none of the synapses pertaining to other time steps are fetched from the external memory 360.

Although the <target, weight> tuple provides a straightforward way to address connections between neurons, storing individual connection parameters for each synapse may consume significant space in the external memory 360, as well as increase processing time due to the latency of data requests and transfers from and to the external memory 360. A technique to mitigate these issues, a generator may be used to create one or all of the target, weight, or delay for a synapse when a spike is received. This technique is effective because it is often more important that given neuron populations have a connection profile rather than a specific neuron having a specific connection. Here, the connection profile refers to a distribution of connections, that every neuron is connected to every other neuron, or the like. The generated values are determinative (e.g., the same output is achieved each time the generator operates on the same input) to ensure that the SNN operates (e.g., trains or performs inferences) consistently.

As an example of operation of the SNN accelerator chip architecture 310, consider the moment that a presynaptic neuron spikes. As discussed above, a neuron spikes because its potential rose above a predetermined (programmable) threshold, as determined by the Neuron Processor 350 where that neuron is maintained. When the neuron spikes, it sends a spike message (including the presynaptic neuron's ID) to the Axon Processor 340 connected to the channel of memory where its synapse data is maintained (e.g., a particular Axon Processor 340A included in the set of Axon Processors 340). This particular Axon Processor 340A adds the spiking neuron ID to a list of spiking neurons, and will begin processing its first delay slot synapses during the next time step.

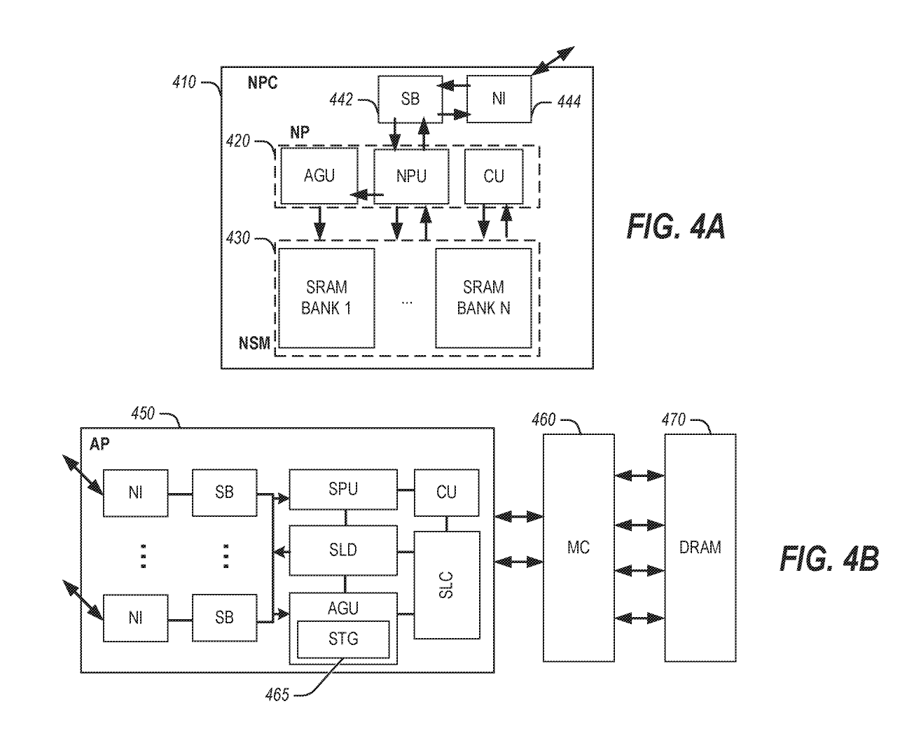

When the next time step begins, the particular Axon Processor 340A fetches (e.g., from the external memory 360A via the Memory Controller 330A) synapse data pertaining to the presynaptic neuron's current delay slot, but the Axon Processor 340A does not yet fetch the synapse data for other delay slots. The presynaptic neuron ID remains in the Axon Processor's list of spiking neurons for several more time steps, until all of its delay slots have been fetched and processed. As the pen-time step synapse list is being fetched, the Axon Processor 340A reads the synapse data for the neuron population to which the presynaptic neuron belongs, using a current synapse from the data as an input to the generator to create one of the target neuron, weight of the synapse, or even the delay slot, to create spike messages, which are sent out to postsynaptic neurons with the specified weight. Each such spike message leaves the Axon Processor 340A and goes back into the Neuron Processors 350, where it finds the particular Neuron Processor 350 in charge of the particular postsynaptic neuron. Additional examples are discussed below with respect to FIGS. 4B and 6-9.

Once the spike message is delivered, the particular Neuron Processor 350 will fetch the postsynaptic neuron's state from a local SRAM (not shown); this Neuron Processor will then modify the target neuron's potential according to the weight of the spike message, and then write the neuron state back to its local SRAM. At the end of each time step, all of the neurons in all of the Neuron Processors 350 must be scanned to see if they spiked during that time step. If they have, the neurons send a spike message to the appropriate Axon Processor 340, and the whole process begins again. If a neuron does not spike during this time step, then its potential will be reduced slightly, according to some “leak” function. Other variations to the operation of the neural network may occur based on the particular design and configuration of such network.

In an example, a neuromorphic hardware configuration of the SNN accelerator 310 may be implemented (e.g., realized) through an accelerator hardware chip including a plurality of neuromorphic cores and a network to connect the respective cores. As discussed in the following configurations, a respective neuromorphic core may constitute a “neuron processor cluster” (hereinafter, NPC), to perform the operations of the neuron processors 350, or an “axon processor” (AP), to perform the operations of the axon processors 340. Thus, in contrast to a conventional neuromorphic hardware design where a single core type—distributed across a network—includes processing capabilities for both neurons and axons, the present design includes two core types distributed across a network that are separated into neuron and axon functions.

FIG. 4A illustrates an example configuration of a Neuron Processor Cluster (NPC) for use in the present neuromorphic hardware configuration (e.g., the architecture 310 discussed in FIG. 3). As shown, the NPC 410 is comprised of three main components: one or more Neuron Processors 420 (NPs), an SRAM-based Neuron State Memory 430 (NSM), and a connection to the on-chip network (the Network Interface (NI) 444 and Spike Buffer (SB) 442). In an example, processing of all neurons is performed in a time multiplexed fashion, with an NP 420 fetching neuron state from the NSM 430, modifying the neuron state, and then writing the neuron state back before operating on another neuron. The NSM 430 may be multi-banked to facilitate being accessed by more than one NP 420 in parallel.

When a spike message (e.g., an inbound spike) arrives at the NPC 410, the spike message is buffered at the SB 442 until the message may be processed. In an example, an Address Generation Unit (AGU) determines the address of the postsynaptic neuron in the NSM 430, whose state is then fetched, and then the Neuron Processing Unit (NPU) adds the value of the spike's weight to the postsynaptic neuron's potential before writing the neuron state hack to the NSM 430. At the end of the current time step, all neurons in all NPCs are scanned by the NPUs to see if their potential has risen above the spiking threshold. If a neuron does spike, a spike message is generated, and sent to the appropriate Axon Processor via the NI 444.

In an example, the NPU is a simplified arithmetic logic unit (ALU) which only needs to support add, subtract, shift and compare operations at a low precision (for example, 16-bits). The NPU is also responsible for performing membrane potential leak for the leaky-integrate-fire neuron model. Due to time multiplexing, the number of physical NPUs is smaller than the total number of neurons. Finally, a Control Unit (CU) orchestrates the overall operation within the NPC 410, which may be implemented as a simple finite-state machine or a micro-controller.

FIG. 4B illustrates an example configuration of an Axon Processor (AP) 450 for use in the present neuromorphic hardware configuration (e.g., the architecture 310 discussed in FIG. 3). The AP 450 includes a memory pipeline for storing and accessing the synaptic data, as the synaptic state is stored in an external high bandwidth memory and accessed via various Axon Processors (AP). For example, as shown in FIG. 4B, the AP 450 is connected to DRAM 470 via a Memory Controller (MC) 460.

Similar to the NPC 410, the AP 450 employs NIs and SBs to send and receive spike messages to/from the network-on-chip. In order to generate the spike messages to send to the postsynaptic neurons, an AGU first generates the corresponding address for a synapse list of the neuron population corresponding to the presynaptic neuron. The synapse list may include headers containing information regarding the length, connectivity, type, etc. of the synapses. A Synapse List Decoder (SLD) is responsible for parsing the synapse list and identifying such headers, target neuron IDs, synaptic weights and so on. The SLD works in conjunction with the AGU to fetch the entire synapse list. Synapse list sizes may vary between presynaptic neurons.

In an example, synapse lists are organized as delay slot-ordered, so the AP 450 will fetch only the list of synapses for the current delay slot, which is temporarily buffered at a Synapse List Cache (SLC). The AP 450 sends out spike messages of the current delay slot to the network. If the SNN size is small enough, and the SLC is large enough, synapses in the next delay slots may be pre-fetched and kept in the SLC. Reading a synapse list from the external memory (the DRAM 470) has very good spatial locality, leading to high bandwidth.

To implement procedural connection modes, the AGU of the AP 450 may include a spike target generator (STG) 465. The STG 465 is electronic hardware (e.g., a circuitry as described below with respect to FIG. 10) that generates one or more of a target neuron identifier (e.g., target, target neuron ID, etc.), a synaptic weight, or the delay for a given spike message.

The STG 465 is arranged to receive a spike indication. As part of the AP 450, the actual spike message is not received by the STG 465, but rather an activation that corresponds to a spike. Thus, the spike indication is an activation of the STG 465 to implement a connection mode as described below.

The STG 465 is arranged to load a synapse list header based on the spike indication. In an example, to load the synapse list header includes receiving the synapse list header on an interface (e.g., a wire, interconnect, or via a register). In the context of the illustrated AP 450, the synapse list header may be retrieved from the external memory 470 via the MC 460, or retrieved from the SLC by, for example, the AGU. The synapse list header identifies a generator function. In an example, the synapse list header identifies the generator function by including the generator function. In an example, the synapse list header identifies the generator function via a reference (e.g., index, serial number, etc.). Here, the generator function is stored elsewhere, such as in the external memory 470, or within the hardware of the AP 450 (e.g., the STG 465, the AGU, etc.), or elsewhere.

The STG 465 is arranged to execute the generator function identified in the synapse list header to produce a spike message. Here, the generator function accepts a current synapse value as input. The current synapse is a synapse from the synapse list. As the synapses from the synapse list are traversed, the current synapse corresponds to the synapse being processed when a portion of the spike message corresponding to that synapse is created. The portions of the spike message that may be created include one or more of a target (e.g., destination) neuron ID, a synapse weight, or a delay. Thus, if there are five synapses in the synapse list, assuming that the spike message creation iterates over the list to create spike messages for each synapse in the list, the second iteration has the second synapse as the current synapse. This identifier (e.g., the number 2 when on the second iteration) is accepted as an input (e.g., parameter) to the generator function and is upon which certain connections modes base the subsequent generated portions of the spike message. Thus, in an example, the current synapse value is a numerical value at an increment corresponding to a position of a current synapse in relation to other synapses in a synapse list that corresponds to the synapse list header. In this example, the synapse list header may include only a numerical value of how many synapses are represented by the header. The incrementing count may then proceed by starting at one, incrementing by one for each spike message created, and ending when the count is equal to the value stored in the synapse list header.

In an example, the synapse list is a fan-out synapse list corresponding to a second neuron originating the spike indication (e.g., a presynaptic neuron). In an example, the synapse list is a fan-in synapse list corresponding to the neuron (e.g., postsynaptic or target neuron). The difference between fan-out and fan-in primarily resides in to which neuron (e.g., presynaptic or postsynaptic) the synapse list corresponds. The operator of the generator function may also be modified to reflect this change representation of the neuron connections, however, the change is likely to be relatively small if it is needed at all.

In an example, the generator function implements a spatial connection mode. A spatial connection mode signifies that the generator creates a target neuron ID—for fan-out—or source neuron ID—for fan-in—for the spike message. In an example, the generator function implements an all-to-all spatial connection mode. The all-to-all spatial connection mode creates a correspondence between every node in a first neuron population to every node in a second population. Here, because the spike message originates from one node, the all-to-all spatial connection mode may operate by iterating through every synapse in the synapse list and adding, for example, the numerical value of the current increment to an offset for the target neuron population. Thus, although neuron populations are involved, the result is a specific connection between each neuron.

In an example, the generator function operates by locating a beginning of a contiguous list of synapse weights using the current synapse value and assigning an increment to each element of the contiguous list of synapse weights. The neuron identifier (e.g., target neuron ID) for each destination neuron may then be derived via the increment to each element of the contiguous list of synapse weights. In this example, the weights for the different synapses are not created by the generator function. Thus, they are stored in the external memory 470. To simplify and speed the retrieval, the weights are stored contiguously in the external memory 470, permitting batch retrieval as well as a straightforward correlation to the current synapse. Thus, at synapse zero, zero is multiplied by a weight offset (e.g., the number of bits used for a given weight) and added to the address of the beginning of the weight list. For synapse one, one is multiple by the weight offset and added to the beginning of the list, and so on. The current synapse also defines the target neuron to which the weight applies. Again, the increment may be added to a lowest neuron ID in the target neuron population to derive the target neuron.

In an example, the generator function implements a sparse connection mode. The sparse connection mode involves at least one neuron from the presynaptic population that is not connected to at least one neuron from the postsynaptic connection. There are, however, a variety of ways to generate the sparse connection mode. For example, the generator function may accept the current synapse as a value to a probability distribution. The corresponding probability of the current synapse determines a number of neurons to which the presynaptic neuron is connected. The total number in the synapse list may be divided by this number to arrive at a step size. The step size is multiplied by the current synapse value and added to the lowest neuron ID of the postsynaptic neuron population, thus causing a distribution of connections between the presynaptic and postsynaptic neurons that follow the probability distribution.

Numerous techniques may be used to generate the sparse connection mode. In an example, the generator function computes set of indices into a contiguous list of synapse weights using the current synapse value (e.g., to get the weight) and derives a neuron identifier for each member of the set of indices. In an example, to compute the set of indices, the STG 465 hashes the current synapse value to produce the set of indices. In an example, the hashing is performed with a hash selected from a list of hashes based on a target connectivity density. Thus a first hash may be used for a first connection density and second hash may be used for a second, different, connection density.

In an example, the generator function implements a tiled connection mode. The tiled connection mode involves a pattern of connections that is repeated, or convoluted, across the synapse list. Thus, for example, synapses one through five may represent connections to neurons one through five, while synapses six through ten represent connections to neurons two through six in the target neuron population. In an example, the target neurons may be determined by a pattern indexed via a modulus operation on the current synapse. Thus, synapse five modulus four equal one; an index to pattern one. The pattern then uses the current synapse value to determine to which of a subset of the target neuron population the current synapse maps. In an example, the generator function combines combining the current synapse value with a set of modifiers to produce a set of destination addresses, and derives a neuron identifier for each of the set of destination addresses. Here, the set of modifiers is applied to the current synapse value (e.g., add one, add two, add three, etc.) to produce a second value that is then, for example, added to the lowest neuron ID of the target neuron population. A variety of modifier sets may be used to produce a variety of tiled connection modes.

In addition to the spatial connection modes, the generator function may create the delay, or temporal, aspect of the synapse. By generating the delay, again, more external memory 470 may be freed as well as reducing time to process spike messages by avoiding the round-trip time to retrieve the delay data. In an example, the temporal element of the spike message is arbitrary. Here, a determinative function, with the current synapse value as a parameter, generates a delay value that results in a random distribution of outputs (e.g., delays) across all possible synapse value parameters. Thus, when looking at the synapses as a whole, the generated delays conform to a random distribution. However, given a particular current synapse, the same delay will be calculated each time.

In an example, the temporal element is fixed. Here, the generator function assigns the same delay without regard to the current synapse value. For example, every synapse is assigned to a two timestep delay slot. In an example, the temporal element is a uniform distribution. Here, the distribution may be generated a determinative function with the current synapse value as a parameter and a uniform distribution of outputs across all possible synapse value parameters. Similar to the random distribution, the uniform distribution is observed across the synapse list, and not with any one synapse delay slot assignment.

The STG 465 is arranged to communicate the spike message to a neuron. After the generator function produces the portions of the spike message, they may be directly sent to the target neuron or passed on to another component of the AP 450, such as the SB to ultimately communicate the spike message to the neuron.

In the course of processing a spike, an AP 450 will dispatch several spike messages to the network which will be consumed by several NPCs. Hence, each AP 450 may have multiple drop-off points to the network (i.e., multiple NIs and SBs) to account for any bandwidth imbalance between NPC 410 and AP 450.

Additionally, the AP 450 may include a Synaptic Plasticity Unit (SPU) which is responsible for providing updates to the synaptic data. These updates may include incrementing, decrementing, pruning, and creating synaptic connections. The SPU may implement various learning rules including spike-timing dependent plasticity (STDP), short/long term depression/potentiation, or the like. SPU updates also may be performed on the synaptic data fetched from memory, before writing it back, to eliminate additional read-modify-writes.

The characteristics of the AP 450, and the STG 465 described above to implement the procedural connection modes provides a per-presynaptic neuron to postsynaptic neuron mapping via a procedure rather than simply storing the connection characteristics in the external memory 470. The arrangement may be used to generate spatial connections (e.g., neuron to neuron), weight for the connections, or delay (e.g., length) or the connections. Thus, not only is the arrangement flexible, it saves external memory space—which may enable either smaller external memories and save die area or power, or enable greater numbers of synapses to be represented with the same sized external memory, and reduces processing latencies introduced by retrieving data from the external memory 470.

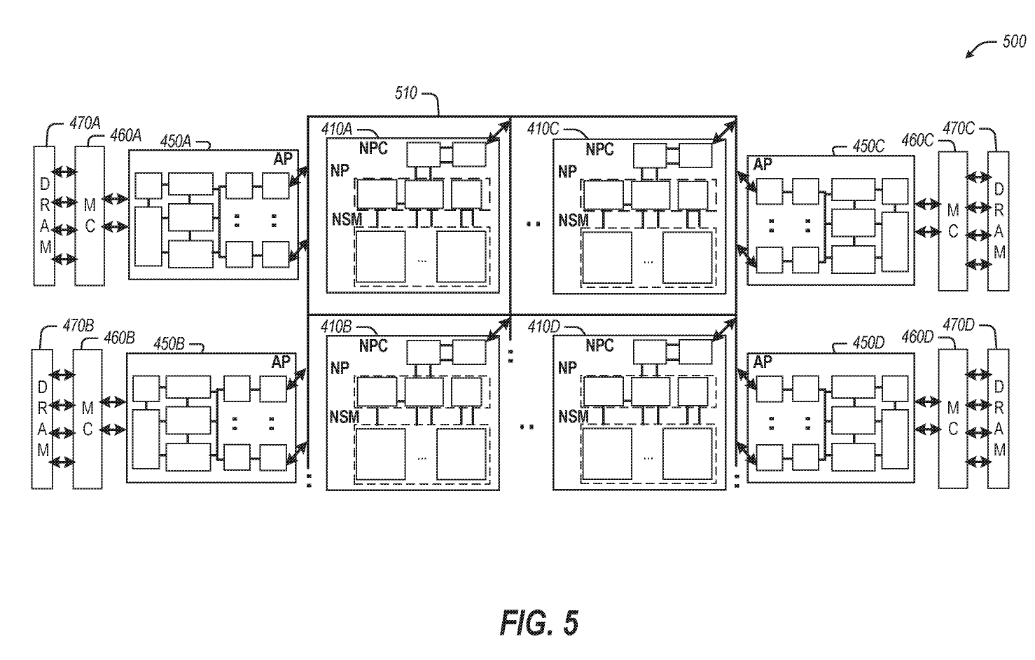

FIG. 5 provides a further illustration of a system-level view 500 of the neuromorphic hardware configuration architecture (e.g., the architecture 310 discussed in FIG. 3). As shown, the architecture includes instances of the APs 450 (e.g., APs 450A, 450B, 450C, 450D) and NPCs 410 (e.g., NPCs 410A, 410B, 410C, 410D), generally corresponding to the instances of such APs and NPCs depicted in FIGS. 4A and 4B. In particular, the architecture in view 500 illustrates the interconnection of the NPCs and APs via a network 510.

For clarity, the neuromorphic architecture for multitasking described above is here reiterated. The Neuron Processors (NP) model a number of neurons, integrating incoming spike weight messages to change neuron membrane potential values. When a neuron's potential exceeds a threshold, it generates a spike event message, which is sent to an appropriate (e.g., predetermined, closest, available, etc.) Axon Processor (AP). According to the neuron identifier (ID) of the spike event message, the AP fetches the corresponding list of synapses from the external memory (EM) via its memory controller (MC). The AP then sends spike weight messages to the NPs of all of the target neurons in the synapse list, which causes those neurons' potentials to change, continuing the cycle.

In the context of a single SNN operating on the neuromorphic hardware (no virtualization or multitasking), there is only one set of neurons that operate from the NPs, and one set of synapse lists that are stored in the EMs. When a neuron spikes, its neuron ID (Ns), which is sent to the AP as part of a spike event message, is totally unambiguous as to which synapse list should be fetched from the EM and processed. Furthermore, when a synapse identifies a target of a spike weight message (Nt), there is no ambiguity as to which neuron in the NPs should be sent the message.

However, when there is a plurality of SNNs being processed by the neuromorphic hardware, there is ambiguity in both Ns and Nt. When the AP receives a spike event message, the AP must distinguish which Ns spiked to fetch the correct synapse list. Further, when the AP is processing the synapse list, the AP must distinguish which Nt to send the spike weight message. To address this issue, Ns and Nt are recast as LNIDs and the AP (e.g., via a NATU) translates between LNID and PNID addresses to isolate individual SNNs that are simultaneously operating on the neuromorphic hardware.

Once these translation and isolation components are in place, the processing elements (e.g., NPs and APs) are free to process whatever work items they receive, according to a scheduling algorithm (e.g., first-come-first-served). In traditional central processing units (CPUs), simultaneous multithreading (SMT) operates by interleaving instruction execution, which may analogous to the previously mentioned work items, to increase CPU resource utilization rates. In the context of this SNN accelerator, the granularity of the interleaved work items may be different based on the types of processing elements in the system (e.g., NP vs. AP).

In an example, for the NPs, a work item may be either updating an individual neuron's membrane potential when it receives a spike weight message, or the work item may be the entire operation of advancing to the next time step by looking for new spikes and leaking all of its neurons' membrane potentials within the SNN. In an example, for APs, a work item may be the whole process of fetching a synapse list from memory, processing it, and sending out all spike weight messages to the target NPs, or the work item may be sending out an individual spike weight message. These work items may each span a significant time period, but there may also be long idle periods between these work items from a single SNN, or within a given work item (e.g., waiting to fetch a synapse list from memory may leave the AP or NP idle). Accordingly, it is valuable to have work items ready to go from a plurality of SNNs to reduce NP or AP idleness and thus increase resource utilization.

FIG. 6 is a block diagram that illustrates an example of an STG 600 to implement an aspect of procedural neural network synaptic connection modes, according to an embodiment. The STG 600 may be implemented as an application specific integrated circuit (ASIC), a field programmable gate array (FPGA), or an IP block in a larger circuit, such as the Axon Processors described above. As illustrated, the STG 600 includes a synapse counter 605 that accepts an increment as a value. The increment may be one in an all-to-all connection mode, or may be greater than one in tiled connection modes, for example. The output of the synapse counter 605 is a current synapse, and is consumed by the offset generator 610 of the STG 600. The offset generator 610 may also optionally accept one or more of a mode, hash, offset modifier, or delay to implement some of the connection modes. These values may be communicated to the offset generator 610 as in a register as an index value. The register may also include a field, or predetermined bit pattern, to indicate what type of data the index refers. The offset generator 610 uses the current synapse value to derive an offset into a target neuron population. The target population beginning neuron ID 615 is a register, or the like, that provides a value to which the output of the offset generator 610 is combined (e.g., added). The result of this combination is the target neuron ID 620 in spatial generation, a delay slot in temporal generation, and a weight otherwise.

The following illustrates a use case for the STG 600. When the SLH is fetched and decoded, the STG 600 produces target neuron IDs for weights streamed from the synapse list. Here, the synapse counter 605 may determine which synapse the STG 600 is working on, acting as an index into the synapse list. The offset generator 610 uses the synapse counter output (e.g., value) and a configuration state—such as Mode ID, Hash ID, Source Neuron ID, or Delay Slot—to output an offset. This offset is added to the target population's beginning neuron ID 615 to determine the final target neuron ID of the synapse. For a given offset generator configuration, each synapse counter value will generate a unique offset value (e.g., between zero and Max_Offset). This ensures that a source neuron is not connected to a particular target more than once. However, different offset generator configurations (e.g., with different source neuron IDs, for example) may generate the same offset.

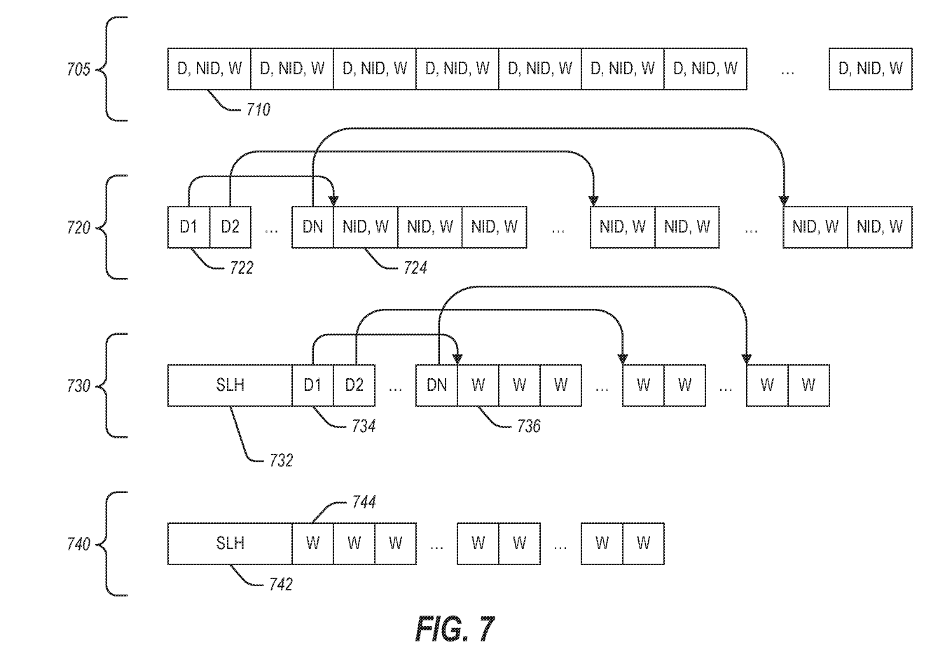

FIG. 7 illustrates examples of memory arrangements for spike target data, according to an embodiment. The traditional arrangement 705 includes several records where each record 710 includes all connection data, such as a delay (D), target neuron ID (NID), and weight (W). Because there are usually a finite number of delay slots supported or used in a neural network, the traditional arrangement 705 may be made more efficient by collecting synapse data into delay slot base continuous lists of records preceded by delay slot pointers. Thus, delay slot pointer D1 722 includes a memory address to the first record 724 in a contiguous set of records for delay slot one. This delay slot arrangement 720 reduces the per-connection record 724 by omitting the delay slot data in the record.

The procedural spatial arrangement 730 adds the SLH 732 while preserving the delay slot pointer and grouping of the delay slot arrangement 720. The SLH 732 includes the information used by the STG described above to generate a target neuron ID. The delay pointer 734 is a memory pointer to the beginning of a contiguous list of weights 736. Thus, the only per-synapse data that is stored are the weights 736.

The procedural spatial-temporal arrangement 740 uses the SLH 742 to generate both the target neuron IDs and the delay, leaving only weights 744 as per-connection data in the memory. In an unillustrated spatial-temporal-weight arrangement, only the SLH is stored in memory for a given synapse list. Because these arrangements are contiguous memory areas, it is possible to mix and match them. Thus, a first population of target neurons may be served by the spatial-temporal arrangement 740, while a second population of neurons may use the traditional arrangement 705. This may be useful when, for example, an already trained neural network model is imported from an external source in which specific neuron connections and weights have been chosen by the training—for the second population, while the first population is an untrained neural network—in which the characteristics of the population interactions instead of the precise connections are important to the neural network design.

The following reviews the various connections modes described herein with reference to various memory arrangements, some illustrated in FIG. 7, and some not. An SNN is like any graph with nodes and edges. As used herein, the nodes are neurons and the edges between neurons are synapses. There may be many synapses associated with each neuron. A synapse may be represented by source or destination neuron IDs, a synaptic weight between them, and the synaptic connection delay. Thus, the synapses may represent both tune and space aspects of neuron connections. Generally the weight associated with the synapse is represented with a low precision value (e.g., 8-bits or 16-bits). However, as the network size gets larger, the number of bits used to address the neurons may become unwieldly. For example, a sixteen million neuron network with sixteen delay slots will use 28-bits—24-bits for spatial information and 4-bits for temporal information—to address the 8-bit or 16-bit weight.

As noted above, there are several ways to store the synaptic information, such as in a fan-out or a fan-in synapse list per neuron. A fan-out synapse list maintains a list of outgoing connections for a presynaptic a neuron. In the traditional arrangement 705, each entry includes a target neuron ID, a synaptic delay, and a weight. Again, the synapses may be sorted according to their delay slot, where synapse list includes pointers to the beginning of each delay slot synapses, according to the delay slot arrangement 720. These levels of granularity are not needed, however, when structured synaptic connection modes between neuron populations are used. SNN developers may create populations of neurons and connect them to each other using a procedure instead of manually connecting individual neurons. Connection modes capture these structured synaptic connections without storing all of the details in memory.

In an example, connection mode identifiers, along with their metadata, may be kept in an SIM, associated with each synapse list. For example, the SLH 732 for the spatial arrangement 730 enables target neuron IDs to be removed from the per connection data in contrast to the traditional arrangement 705 and the delay slot arrangement 720. To read a synapse list, first the corresponding SLH is fetched and decoded. The information in the SLH provides pointers, synapse count, target neuron population address, etc., enabling the rest of the synapse list to define the connections between the presynaptic neuron and the post synaptic neurons. Again, connection modes may include spatial or temporal connectivity information, as illustrated in the spatial arrangement 730 and the spatial-temporal arrangement 740.

There are many possible spatial and temporal connection modes that may be use. For example, spatial connection modes may include all-to-all, sparse, tiled, or one-to-one. In an all-to-all connection mode, dense spatial connections between neuron populations (e.g., fully connected neuron populations) are implemented. Here, a source neuron is connected to all the neurons in the target population. In an example, an SLH that supports the all-to-all connection mode may include a mode identifier, a beginning neuron ID of the target population, and number of connections of the presynaptic neuron. The per connection data contains the synaptic weights—and, in an example, corresponding delays depending on temporal connectivity—but not target neuron IDs (e.g., spatial arrangement 730).

In an example, when the SLH is fetched, a synapse list decoder decodes the header and a STG sequentially generates the neuron IDs starting from the beginning neuron ID of the target population. While this occurs, weights corresponding to the SLH are sequentially streamed from the memory sequentially. Thus, weight and neuron ID pairs sent out to procedurally complete an element of the outgoing spike message.

Another possible connection mode is a sparse connection mode. For example, a random sparse spatial connection between neuron populations may be used. In this example, a neural network designer may express sparse connectivity between two neuron populations by connection density (e.g., how many synapses are formed out of all possible connections between the neuron populations). This technique operates in circumstances where the designer is not concerned about the individual neuron connections, but rather is concerned with the overall connection density. Thus, source and destination neuron IDs may be selected randomly to create the connections until a specified number of synapses is achieved. However, to permit the generator function to re-generate the connection again and again, the selection is determinative given the inputs. A hashing technique may be used to achieve the randomness of the connections while achieving determinative reconstruction of the connection in future iterations.

For example, the SLH may include a hash identifier in addition to a connection mode identifier, beginning or end neuron ID of the target population, or a number of outgoing synapses of the neuron; omitting neuron IDs altogether. When the SLH is fetched, a range of the possible target neuron IDs are generated based on the beginning or end neuron ID of the target population. Based on the number of connections in the synapse list, a synapse count increment amount is then obtained (e.g., retrieved, received, determined, etc.) generate the specified number of synapses. An offset generator may produce a randomized sequence of offsets that are unique to the given hash identifier and the source neuron ID. Thus, the STG, or similar processor, produces the same sequence of target neuron IDs for the given source neuron ID and hash ID.

Hash based sequences may limit the spatial connectivity where the target neurons cannot be arbitrary. Thus, in an example, multiple hash identifiers may be used to generate different hash sequence of connection offsets for different neuron populations.

A tiled spatial connection mode may also be useful in a number of use cases. A tiled connection may resemble receptive fields in a brain; a reason for its use in implementing convolutional networks. Given a size of a tile, and a stride between different tiles, target neuron IDs of the synapses may be generated. For example, the SLH may include a connection mode identifier, a beginning or end neuron ID of the target population, along with a tile size and tile stride. The tile stride captures the stride (e.g., number of neurons to move) between consecutive tiles. For example, convolutional connections often use stride of one where consecutive tiles are partially overlapped. In contrast, pooling connections may use a stride that is equal to the tile width so that each tile is mapped to non-overlapped parts in the source neuron population.

Target neuron ID generation for this mode may be slightly different than in other connection modes. For example, a synapse counter may hold a value for a current synapse in the synapse list, while an offset generator may produce the neuron ID offset to the target population. Assuming that the source population size is Ks*Ks, target population size is Kt*Kt, tile size is w*w, and the tile stride is s, the following may be used to generate a target neuron offsets (n_out) for a given source neuron offset (n_in):

Xin=n_in % Ks; Yin=n_in/Ks;

foreach dx,dy=−w/2; dx,dy<w/2; dx,dy+=s
Xout=Xin+dx; Yout=Yin+dy;
if(0<=Xout,Yout<Kt)/Boundary check
   Nout=Xout+Yout*Kt
   Wout=tile[dx][dy]; //Indirect weight

This algorithm describes a procedure to generate target offsets in pseudo-code description of a hardware implementation and may be implemented differently in software. The technique uses simple shift, add, compare, and count operations (e.g., divide, multiply, and modulo typically operate on low-precision integers) that may be controlled by an FSM. Thus, the technique may be efficiently implemented in hardware.

Using this technique, the target neuron IDs may be generated given the tiled connection configuration and the source neuron ID. In an example, the boundary check condition may be provided in the SLH. Here, padding may be employed in the source population to even out irregularities in the connections at the edges of the populations (e.g. full vs. valid convolutional connections).

In a one-to-one connection mode, each source neuron has a single target neuron. In an example, the connections may be ordered sequentially. In an example, one-to-one connection information may be explicitly stored in the SLH, the overhead of having an SLH entry per neuron for a single target connection may be costly in terms of memory efficiency. In an example, this connection mode may benefit from a per-population SLH in which there is a single SLH shared for the population).

The spatial connection modes described above may be joined or by a temporal connection mode that procedurally generates a delay for a given synapse. An example temporal connection mode is the arbitrary connection mode. An arbitrary temporal connectivity eliminates constraints on the number of connections in each delay slot in a synapse list. This connectivity may be implemented via pointers to the beginning of the synapses belonging to a delay slot in a delay ordered synapse list (e.g., arrangement 730).

Fixed delay is another example of a temporal connection mode. This mode may be useful in neural network models where a neuron population is unconcerned with, or intentionally omitting, temporal impact on spike messages (e.g., the neuron population or network is focused only on spatially connectivity). Here, outgoing synapses may be assigned have a fixed delay value (e.g., hardcoded, specified during setup, read from a configuration, etc.) There are also situations in which temporal variation is suppressed to help ensure that spikes reach their targets the same time. For example, inhibitory connections in a winner-take-all topology may inhibit the loser neurons at the same time (e.g., simultaneously) for fair operation. To achieve this effect, the SLH may include the fixed-delay connection mode that eliminates the need to explicitly store delay slot information (e.g., arrangement 740).

A further temporal connection mode is a uniform distribution. Similar to the sparse spatial connectivity, a neural network developer may want temporal variation in the synapses without specifying delays for individual synapses. The uniform distribution mode distributes the total number of synapses to each delay slot uniformly. In an example, the SLH may include the number of delay slots to which the synapses are distributed. Again, because temporal information does not need to be stored explicitly, this technique may use the memory arrangement 740.

In addition to spatial and temporal data about synapse, weight data may also be compressed. For example, indirect weights may be used. For example, multiple synapses may use (and collectively update) the same weights while connecting heir targets. This may occur in convolutional (e.g., tiled) connections, where synapses within a tile have a unique set of weights but all the tiles use the same weights when connecting to their target. To represent such a connection, only one set of weights may be shared across tiles. Each synapse may specify the weight it is using from the tile by holding a pointer to the weight. This technique eliminates the weights to be replicated for each synapse.

In additional weight generation use cases also exist. For example, static synapses between certain populations may be used for regulating general activity in the network. Here, the static nature of the connection means that the weights of these connections do not change over time. For example, there may be an inhibitory neuron population connected to another, main, neuron population through sparse random connections. The inhibitory neuron population may inject more inhibitory spikes if the main population activity increases above a threshold. Hence, the inhibitory neuron population regulates spiking frequency in the main neuron population via negative feedback. To generate these inhibitory weights, the SLH may store a minimum and maximum value for the weights in addition to a hash identifier (or hash itself). Then, similar to target ID generation, a random distribution but unique set of weights may be generated based on the source neuron ID.

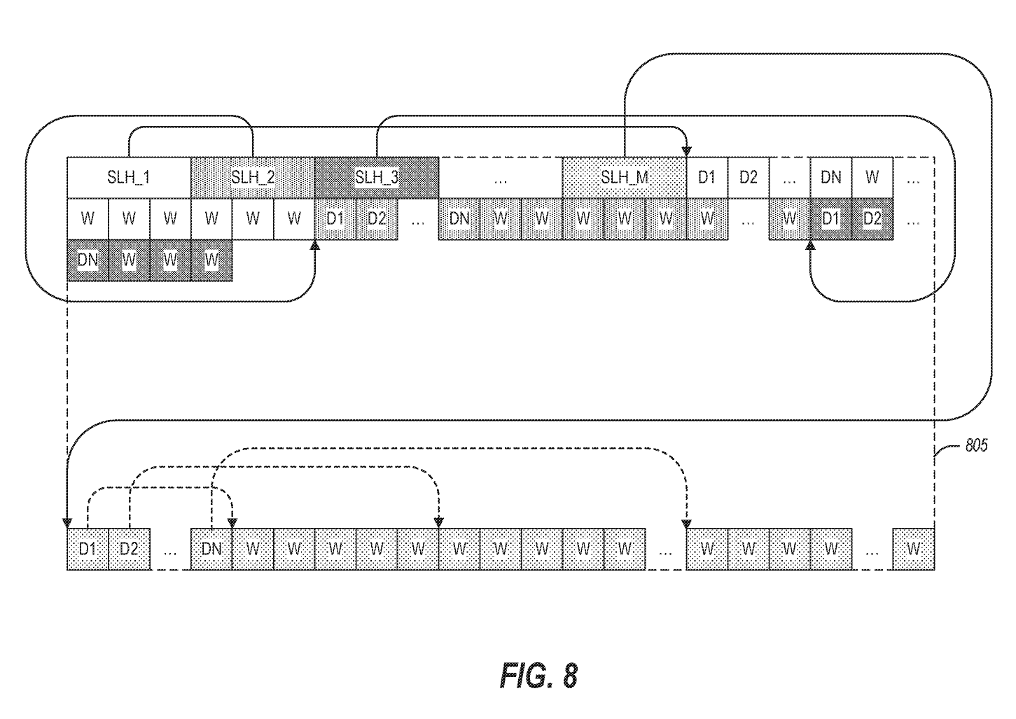

FIG. 8 illustrates an example of a memory arrangement for dislocated synapse list headers (SLHs) and synapse data, according to an embodiment. Because synapse lists may have different sizes, the memory arrangement of synapse lists may benefit from a mechanism to determine where each synapse list begins or ends. However, it may be very costly to keep an on-chip buffer for pointers to each synapse list. A solution to this problem includes separating the SLHs and the per-connection data (e.g., list of weights) as illustrated in FIG. 8. In an example, the SLHs have known fixed sizes. Therefore, the address of an SLH within the memory 805 is determined based on its neuron ID (e.g., presynaptic neuron id in the case of a fan-out list). The neuron id is applied to an SLH size to determine an offset to the specific SLH for that neuron ID from the list of SLH's. Here, the SLHs include pointers to their per-connection data, such as delay slot pointers or weights, so that a synapse list decoder may start streaming the weights once the SLH is decoded.

In an example, like the one-to-one neural network topology described above below, a single SLH may be used per neuron population. Here, the SLH is shared by all the neurons in that population. This provides an extra level of compression within a population. In an example, the population ID of a presynaptic neuron may be determined from a lookup table, which may be memory resident, and the corresponding population SLH is fetched to be able to determine the actual synapse lists.

In an example, a presynaptic neuron may have postsynaptic neurons from different populations and use a different connection mode per population. To handle this, a Population List Header (PLH) may be used. Here, the PLH includes one or more pointers to multiple SLHs. Individual synapse list data layouts for each target population may be implemented as described herein, where the SLH for each source neuron points to its own synaptic list.

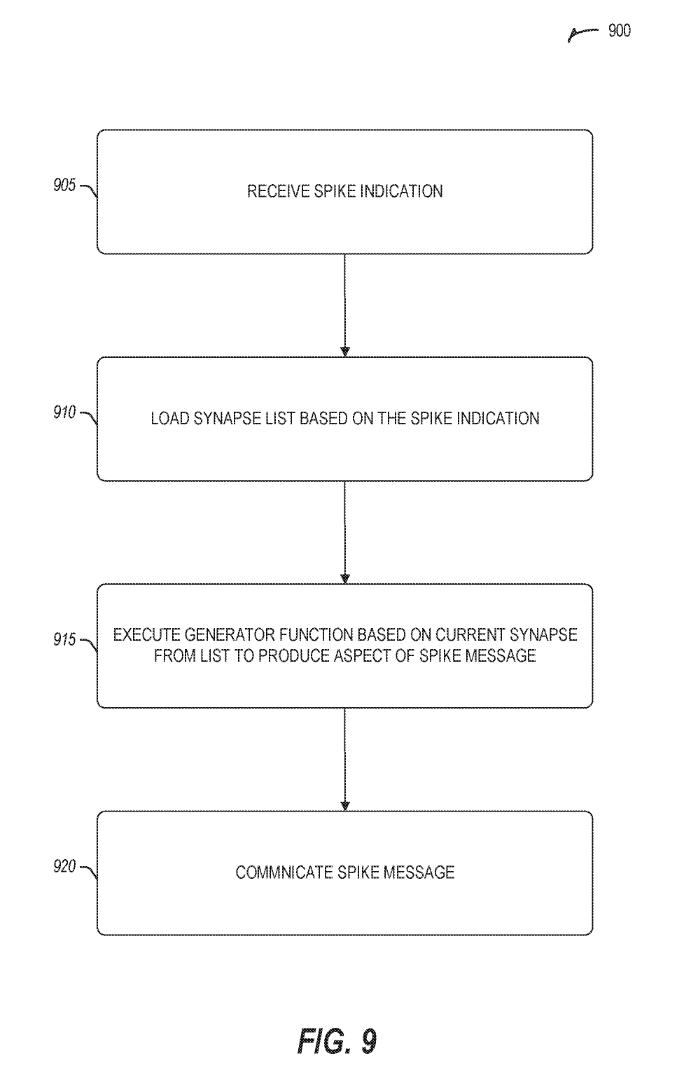

FIG. 9 illustrates a flow chart of an example of a method 900 for neuromorphic hardware multitasking, according to an embodiment. The operations of the method 900 are implemented in electronic hardware, such as that described above with respect to FIGS. 2-5), or below (e.g., processing circuitry).

At operation 905, a spike indication is received.

At operation 910, a synapse list header is loaded based on the spike

At operation 915, a generator function identified in the synapse list header is executed to produce a spike message. Here, the generator function accepts a current synapse value as input. In an example, the generator function is stored in the synapse list header. In an example, the synapse list header includes an identifier for the generator function, the generator function being external to the synapse list header. In an example, the generator function generates a weight element of the spike message.

In an example, the current synapse value is a numerical value at an increment corresponding to a position of a current synapse in relation to other synapses in a synapse list that corresponds to the synapse list header. In an example, the synapse list is a fan-out synapse list corresponding to a second neuron originating the spike indication. In an example, the synapse list is a fan-in synapse list corresponding to the neuron.

In an example, the generator function implements a spatial connection mode. In an example, the generator function implements an all-to-all spatial connection mode. In an example, the generator function includes the following operations: locating a beginning of a contiguous list of synapse weights using the current synapse value; assigning an increment to each element of the contiguous list of synapse weights; and deriving a neuron identifier for each destination neuron via the increment to each element of the contiguous list of synapse weights.

In an example, the generator function implements a sparse connection mode. In an example, the generator function includes the following operations: computing set of indices into a contiguous list of synapse weights using the current synapse value; and deriving a neuron identifier for each member of the set of indices. In an example, computing the set of indices includes hashing the current synapse value to produce the set of indices. In an example, the hashing is performed with a hash selected from a list of hashes based on a target connectivity density.

In an example, the generator function implements a tiled connection mode. In an example, the generator function includes the following operations: combining the current synapse value with a set of modifiers to produce a set of destination addresses; and deriving a neuron identifier for each of the set of destination addresses.

In an example, the generator function generates a temporal element of the spike message. In an example, the temporal element is arbitrary and is generated by a determinative function with the current synapse value as a parameter and a random distribution of outputs across all possible synapse value parameters. In an example, the temporal element is fixed and is generated by assigning the same delay without regard to the current synapse value. In an example, the temporal element is a uniform distribution and is generated by a determinative function with the current synapse value as a parameter and a uniform distribution of outputs across all possible synapse value parameters.

At operation 920, the spike message is communicated to a neuron.

FIG. 10 illustrates a block diagram of an example machine 1000 upon which any one or more of the techniques (e.g., methodologies) discussed herein may perform. Examples, as described herein, may include, or may operate by, logic or a number of components, or mechanisms in the machine 1000. Circuitry (e.g., processing circuitry) is a collection of circuits implemented in tangible entities of the machine 1000 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, movable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1000 follow.

In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a sensor platform, head mounted display, a sensor fusion platform, a controller, a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1000 may include a hardware processor 1002 (e.g., a central processing unit (CPU), a graphics processing unit (GPU), a hardware processor core, neuromorphic accelerator, or any combination thereof), a main memory 1004, a static memory (e.g., memory or storage for firmware, microcode, a basic-input-output (BIOS), unified extensible firmware interface (UEFI), etc.) 1006, and mass storage 1008 (e.g., hard drive, tape drive, flash storage, or other block devices) some or all of which may communicate with each other via an interlink (e.g., bus) 1030. The machine 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The machine 1000 may additionally include a storage device (e.g., drive unit) 1008, a signal generation device 1018 (e.g., a speaker), a network interface device 1020, and one or more sensors 1016, such as a global positioning system (UPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1002, the main memory 1004, the static memory 1006, or the mass storage 1008 may be, or include, a machine readable medium 1022 on which is stored one or more sets of data structures or instructions 1024 (e.g., software) embodying or utilized by any one or more of the techniques or functions described herein. The instructions 1024 may also reside, completely or at least partially, within any of registers of the processor 1002, the main memory 1004, the static memory 1006, or the mass storage 1008 during execution thereof by the machine 1000. In an example, one or any combination of the hardware processor 1002, the main memory 1004, the static memory 1006, or the mass storage 1008 may constitute the machine readable media 1022. While the machine readable medium 1022 is illustrated as a single medium, the term “machine readable medium” may include a single medium or multiple media (e.g., a centralized or distributed database, or associated caches and servers) configured to store the one or more instructions 1024.

The term machine readable medium may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may be further transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software. A transmission medium is a machine readable medium.

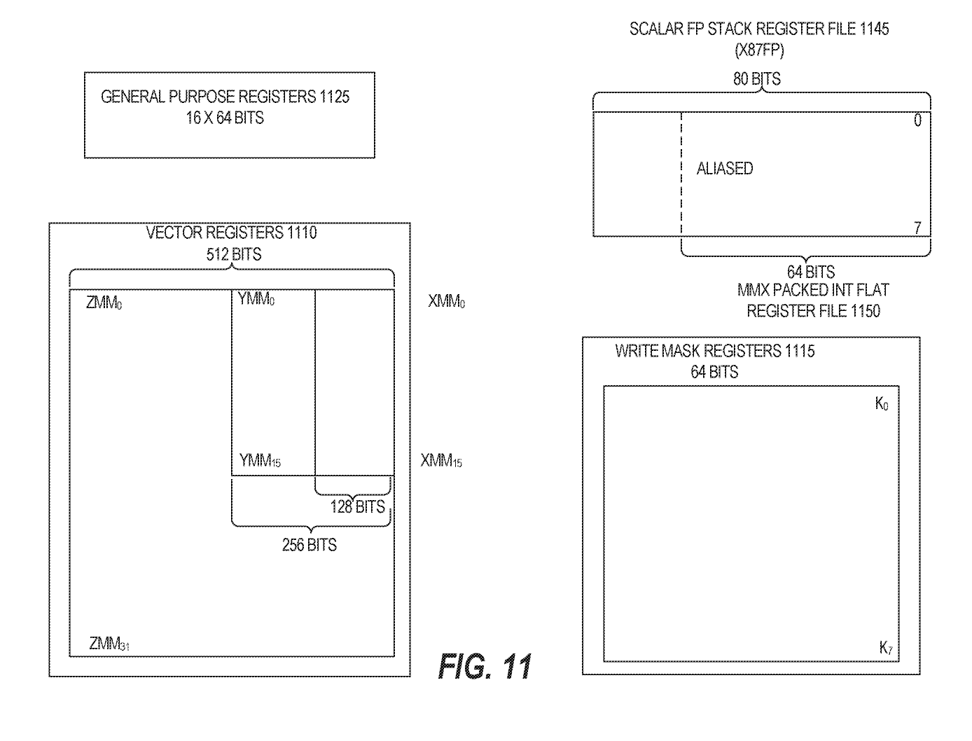

FIGS. 11 through 20 illustrate several additional examples of hardware structures or implementations that may be used to implement computer hardware.

FIG. 11 is a block diagram of a register architecture 1100 according to an embodiment. In the embodiment illustrated, there are 32 vector registers 1110 that are 512-bits wide; these registers are referenced as zmm0 through zmm31. The lower order 256-bits of the lower 16 zmm registers are overlaid on registers ymm0-16. The lower order 128-bits of the lower 16 zmm registers (the lower order 128-bits of the ymm registers) are overlaid on registers xmm0-15.

Write mask registers 1115 in the embodiment illustrated, there are 8 write mask registers (k0 through k7), each 64-bits in size. In an alternate embodiment, the write mask registers 1115 are 16-bits in size. As previously described, in an embodiment, the vector mask register k0 cannot be used as a write mask; when the encoding that would normally indicate k0 is used for a write mask, it selects a hardwired write mask of 0xFFFF, effectively disabling write masking for that instruction.

General-purpose registers 1125—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1145, on which is abased the MMX packed integer flat register file 1150—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers. Alternative embodiments may use wider or narrower registers. Additionally, alternative embodiments may use more, less, or different register files and registers.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Example core architectures are described next, followed by descriptions of example processors and computer architectures.

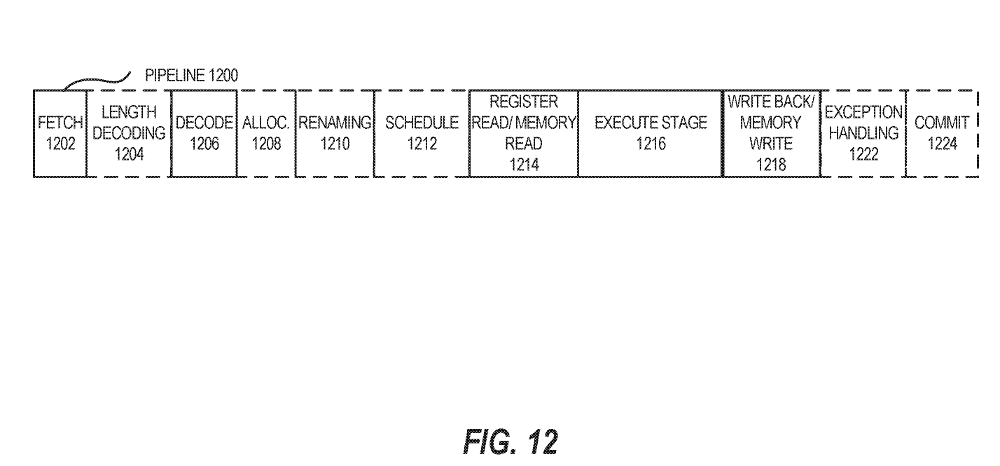

FIG. 12 is a block diagram illustrating both an example in-order pipeline and an example register renaming, out-of-order issue/execution pipeline according to various embodiments. The solid lined boxes in FIG. 12 illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 12, a processor pipeline 1200 includes a fetch stage 1202, a length decode stage 1204, a decode stage 1206, an allocation stage 1208, a renaming stage 1210, a scheduling (also known as a dispatch or issue) stage 1212, a register read/memory read stage 1214, an execute stage 1216, a write back/memory write stage 1218, an exception handling stage 1222, and a commit stage 1224.

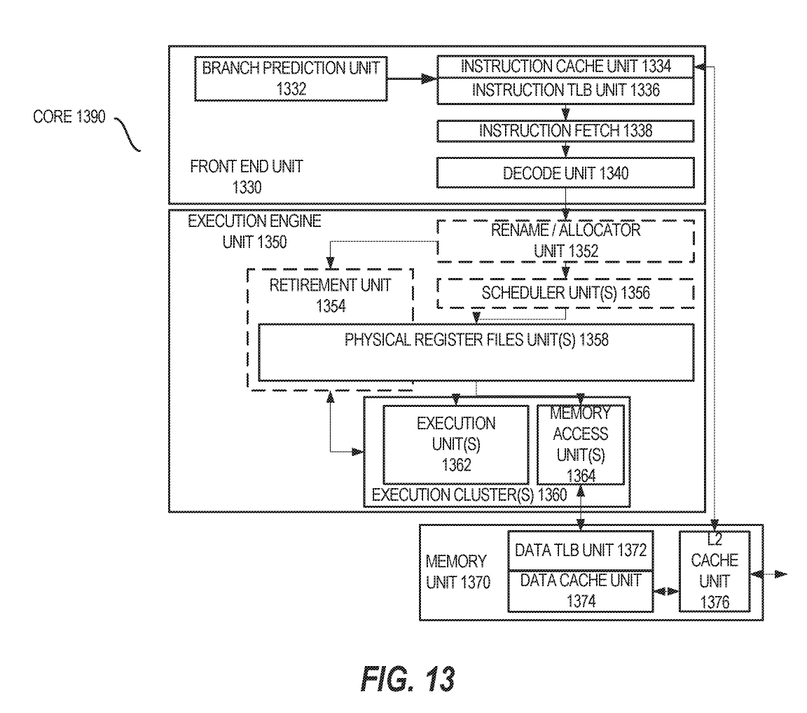

FIG. 13 shows processor core 1390 including a front end unit 1330 coupled to an execution engine unit 1350, and both are coupled to a memory unit 1370. The core 1390 may be a reduced instruction set computing (RISC) core, a complex instruction set computing (CISC) core, a very long instruction word (VLIW) core, or a hybrid or alternative core type. As yet another option, the core 1390 may be a special-purpose core, such as, for example, a network or communication core, compression engine, coprocessor core, general purpose computing graphics processing unit (GPGPU) core, graphics core, or the like.

The front end unit 1330 includes a branch prediction unit 1332 coupled to an instruction cache unit 1334, which is coupled to an instruction translation lookaside buffer (TLB) 1336, which is coupled to an instruction fetch unit 1338, which is coupled to a decode unit 1340. The decode unit 1340 (or decoder) may decode instructions, and generate as an output one or more micro-operations, micro-code entry points, microinstructions, other instructions, or other control signals, which are decoded from, or which otherwise reflect, or are derived from, the original instructions. The decode unit 340 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1390 includes a microcode ROM or other medium that stores microcode for certain macroinstructions (e.g., in decode unit 1340 or otherwise within the front end unit 1330). The decode unit 1340 is coupled to a rename/allocator unit 1352 in the execution engine unit 1350.

The execution engine unit 1350 includes the rename/allocator unit 1352 coupled to a retirement unit 1354 and a set of one or more scheduler unit(s) 1356. The scheduler unit(s) 1356 represents any number of different schedulers, including reservations stations, central instruction window, etc. The scheduler unit(s) 1356 is coupled to the physical register file(s) unit(s) 1358. Each of the physical register file(s) units 1358 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1358 comprises a vector registers unit, a write mask registers unit, and a scalar registers unit. These register units may provide architectural vector registers, vector mask registers, and general purpose registers. The physical register file(s) unit(s) 1358 is overlapped by the retirement unit 1354 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; et The retirement unit 1354 and the physical register file(s) unit(s) 1358 are coupled to the execution cluster(s) 1360. The execution cluster(s) 1360 includes a set of one or more execution units 1362 and a set of one or more memory access units 1364. The execution units 1362 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1356, physical register file(s) unit(s) 1358, and execution cluster(s) 1360 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1364). It should also be understood that where separate pipelines are used, one or more of these pipelines may be out-of-order issue/execution and the rest in-order.

The set of memory access units 1364 is coupled to the memory unit 1370, which includes a data TLB unit 1372 coupled to a data cache unit 1374 coupled to a level 2 (L2) cache unit 1376. In one example, the memory access units 1364 may include a load unit, a store address unit, and a store data unit, each of which is coupled to the data TLB unit 1372 in the memory unit 1370. The instruction cache unit 1334 is further coupled to a level 2 (L2) cache unit 1376 in the memory unit 1370. The L2 cache unit 1376 is coupled to one or more other levels of cache and eventually to a main memory.

By way of example, the example register renaming, out-of-order issue/execution core architecture may implement the pipeline 1200 as follows: 1) the instruction fetch 1338 performs the fetch and length decoding stages 1202 and 1204; 2) the decode unit 1340 performs the decode stage 1206; 3) the rename/allocator unit 1352 performs the allocation stage 1208 and renaming stage 1210; 4) the scheduler unit(s) 1356 performs the schedule stage 1212; 5) the physical register file(s) unit(s) 1358 and the memory unit 1370 perform the register read/memory read stage 1214; the execution cluster 1360 perform the execute stage 1216; 6) the memory unit 1370 and the physical register file(s) unit(s) 1358 perform the write back/memory write stage 1218; 7) various units may be involved in the exception handling stage 1222; and 8) the retirement unit 1354 and the physical register file(s) unit(s) 1358 perform the commit stage 1224.

The core 1390 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1390 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1334/1374 and a shared L2 cache unit 1376, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

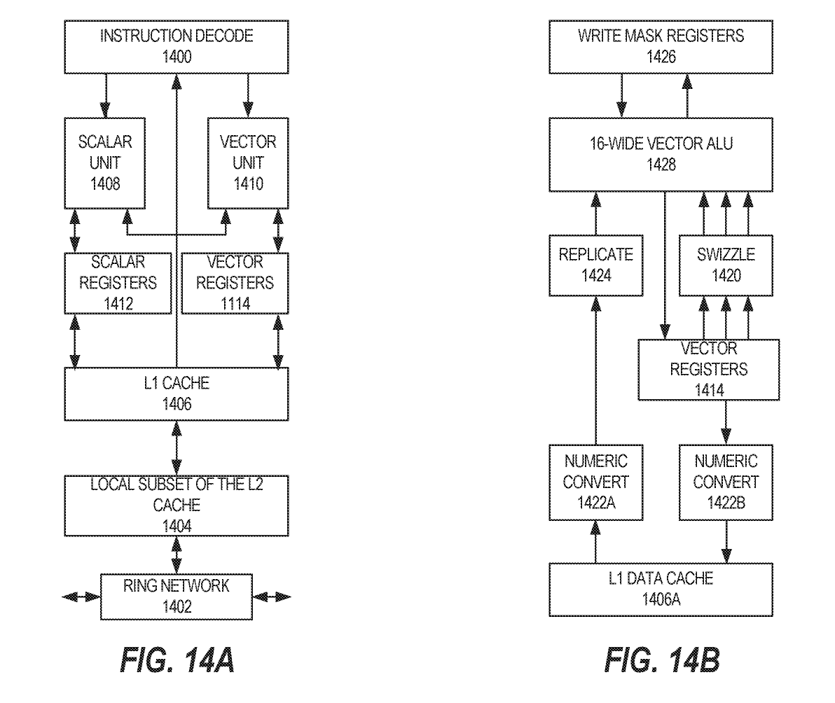

FIGS. 14A-14B illustrate a block diagram of a more specific example in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 14A is a block diagram of a single processor core, along with its connection to the on-die interconnect network 1402 and with its local subset of the Level 2 (L2) cache 1404, according to various embodiments. In one embodiment, an instruction decoder 1400 supports the x86 instruction set with a packed data instruction set extension. An L1 cache 1406 allows low-latency accesses to cache memory into the scalar and vector units. While in one embodiment (to simplify the design), a scalar unit 1408 and a vector unit 1410 use separate register sets (respectively, scalar registers 1412 and vector registers 1414) and data transferred between them is written to memory and then read back in from a level 1 (L1) cache 1406, alternative embodiments may use a different approach (e.g., use a single register set or include a communication path that allow data to be transferred between the two register files without being written and read back).

The local subset of the L2 cache 1404 is part of a global L2 cache that is divided into separate local subsets, one per processor core. Each processor core has a direct access path to its own local subset of the L2 cache 1404. Data read by a processor core is stored in its L2 cache subset 1404 and may be accessed quickly, in parallel with other processor cores accessing their own local L2 cache subsets. Data written by a processor core is stored in its own L2 cache subset 1404 and is flushed from other subsets, if necessary. The ring network ensures coherency for shared data. The ring network is bi-directional to allow agents such as processor cores, L2 caches and other logic blocks to communicate with each other within the chip. Each ring data-path is 2-bits wide per direction.

FIG. 14B is an expanded view of part of the processor core in FIG. 14A according to embodiments. FIG. 14B includes an L1 data cache 1406A part of the L1 cache 1404, as well as more detail regarding the vector unit 1410 and the vector registers 1414. Specifically, the vector unit 1410 is a 16-wide vector processing unit (VPU) (see the 16-wide ALU 1428), which executes one or more of integer, single-precision float, and double-precision float instructions. The VPU supports swizzling the register inputs with swizzle unit 1420, numeric conversion with numeric convert units 1422A-B, and replication with replication unit 1424 on the memory input. Write mask registers 1426 allow predicating resulting vector writes.

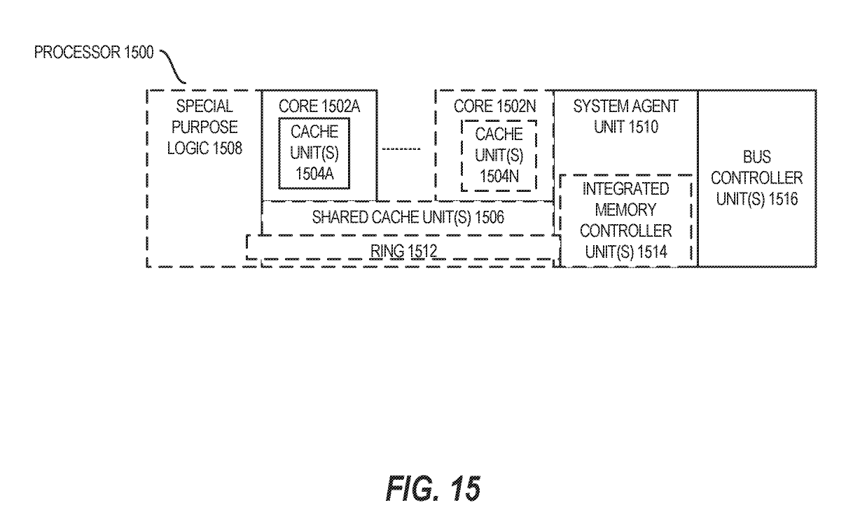

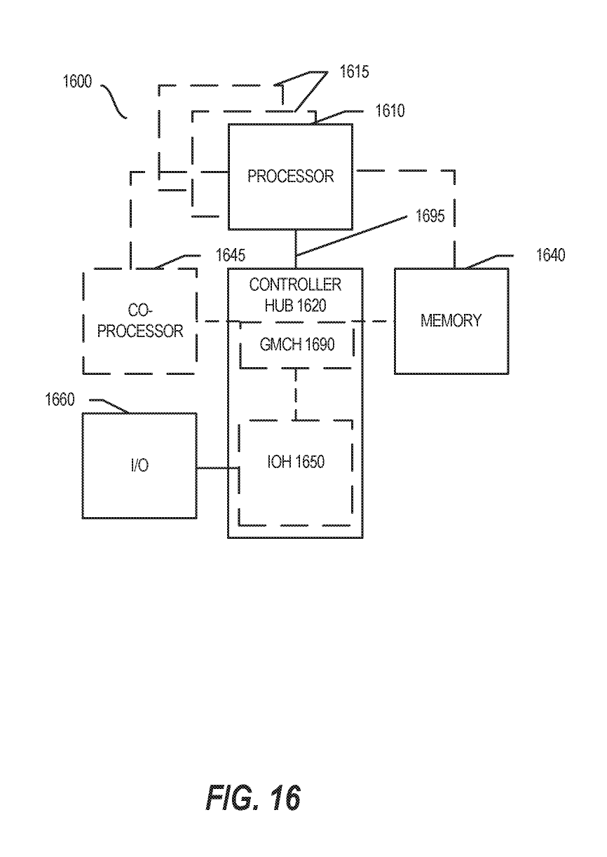

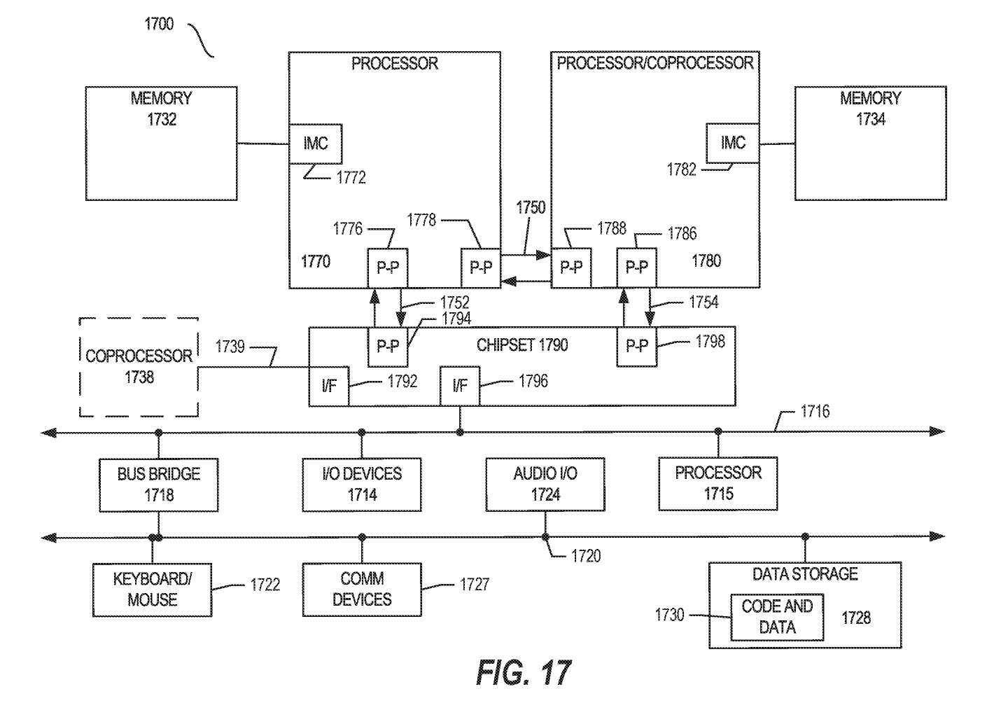

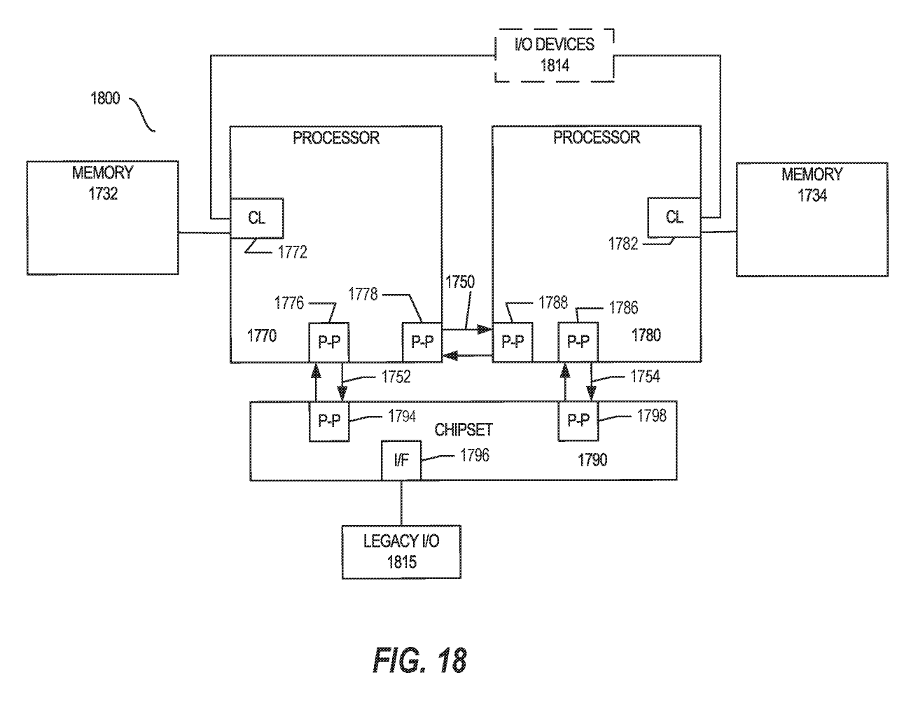

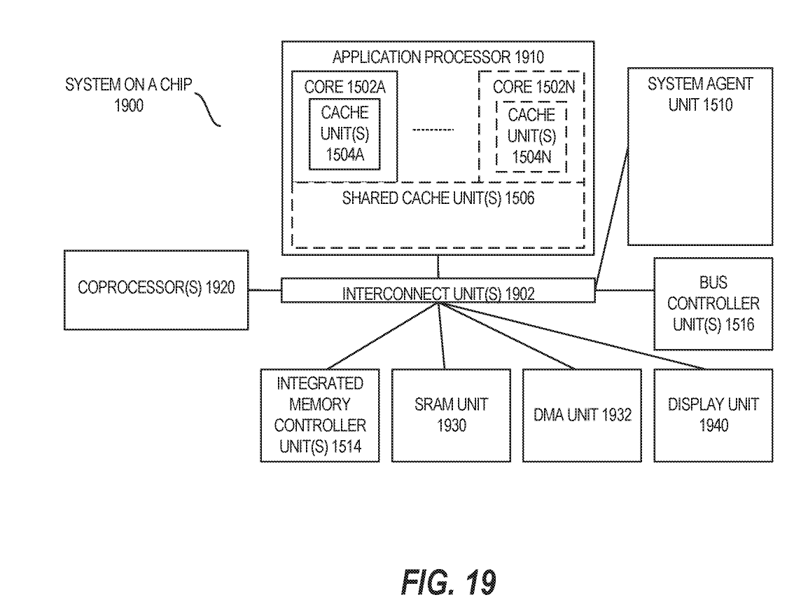

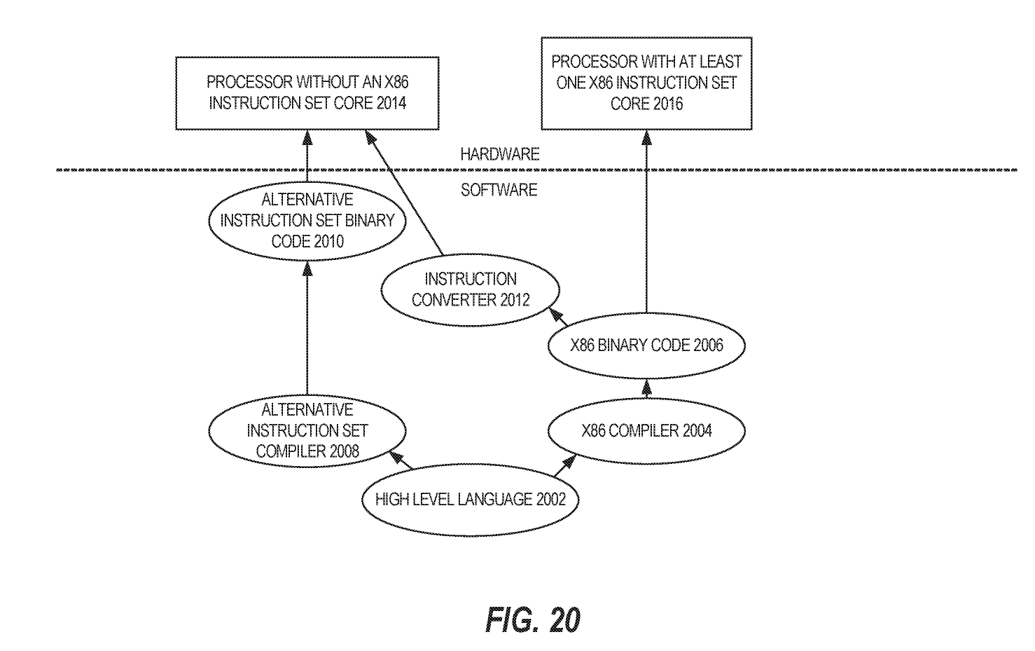

FIG. 15 is a block diagram of a processor 1500 that may have more than one core, may have an integrated memory controller, and may have integrated graphics according to embodiments. The solid lined boxes in FIG. 15 illustrate a processor 1500 with a single core 1502A, a system agent 1510, a set of one or more bus controller units 1516, while the optional addition of the dashed lined boxes illustrates an alternative processor 1500 with multiple cores 1502A-N, a set of one or more integrated memory controller unit(s) 1514 in the system agent unit 1510, and special purpose logic 1508.

Thus, different implementations of the processor 1500 may include: 1) a CPU with the special purpose logic 1508 being integrated graphics and/or scientific (throughput) logic (which may include one or more cores), and the cores 1502A-N being one or more general purpose cores (e.g., general purpose in-order cores, general purpose out-of-order cores, a combination of the two); 2) a coprocessor with the cores 1502A-N being a large number of special purpose cores intended primarily for graphics and/or scientific (throughput); and 3) a coprocessor with the cores 1502A-N being a large number of general purpose in-order cores. Thus, the processor 1500 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1500 may be a part of and/or may be implemented on one or more substrates using any of a number of process technologies, such as, for example, BiCMOS, CMOS, or NMOS.

The memory hierarchy includes one or more levels of cache 1504A-N within the cores 1502A-N, a set or one or more shared cache units 1506, and external memory (not shown) coupled to the set of integrated memory controller units 1514. The set of shared cache units 1506 may include one or more mid-level caches, such as level 2 (L2), level 3 (L3), level 4 or other levels of cache, a last level cache (LLC), and/or combinations thereof. While in one embodiment a ring based interconnect unit 1512 interconnects the integrated graphics logic 1508, the set of shared cache units 1506, and the system agent unit 1510/integrated memory controller unit(s) 1514, alternative embodiments may use any number of well-known techniques for interconnecting such units. In one embodiment, coherency is maintained between one or more cache units 1506 and cores 1502A-N.

In some embodiments, one or more of the cores 1502A-N are capable of multi-threading. The system agent 1510 includes those components coordinating and operating cores 1502A-N. The system agent unit 1510 may include for example a power control unit (PCU) and a display unit. The PCU may be or include logic and components needed for regulating the power state of the cores 1502A-N and the integrated graphics logic 1508. The display unit is for driving one or more externally connected displays.

The cores 1502A-N may be homogenous or heterogeneous in terms of architecture instruction set; that is, two or more of the cores 1502A-N may be capable of execution the same instruction set, while others may be capable of executing only a subset of that instruction set or a different instruction set.

FIGS. 16-19 are block diagrams of example computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to Ha 16, shown is a block diagram of a system 1600 in accordance with an embodiment. The system 1600 may include one or more processors 1610, 1615, which are coupled to a controller hub 1620. In one embodiment the controller hub 1620 includes a graphics memory controller hub (GMCH) 1690 and an Input/Output Hub (IOH) 1650 (which may be on separate chips); the GMCH 1690 includes memory and graphics controllers to which are coupled memory 1640 and a coprocessor 1645; the IOH 1650 is couples input/output (I/O) devices 1660 to the GMCH 1690. Alternatively, one or both of the memory and graphics controllers are integrated within the processor (as described herein), the memory 1640 and the coprocessor 1645 are coupled directly to the processor 1610, and the controller hub 1620 in a single chip with the IOH 1650.

The optional nature of additional processors 1615 is denoted in FIG. 16 with broken lines. Each processor 1610, 1615 may include one or more of the processing cores described herein and may be some version of the processor 1500.

The memory 1640 may be, for example, dynamic random access memory (DRAM), phase change memory (PCM), or a combination of the two. For at least one embodiment, the controller hub 1620 communicates with the processor(s) 1610, 1615 via a multi-drop bus, such as a frontside bus (FSB), point-to-point interface such as QuickPath Interconnect (QPI), or similar connection 1695.

In one embodiment, the coprocessor 1645 is a special-purpose processor, such as, for example, a high-throughput MIC processor, a network or communication processor, compression engine, graphics processor, GPGPPU, embedded processor, or the like. In one embodiment, controller hub 1620 may include an integrated graphics accelerator.

There may be a variety of differences between the physical resources 1610, 1615 in terms of a spectrum of metrics of merit including architectural, microarchitectural, thermal, power consumption characteristics, and the like.

In one embodiment, the processor 1610 executes instructions that control data processing operations of a general type. Embedded within the instructions may be coprocessor instructions. The processor 1610 recognizes these coprocessor instructions as being of a type that should be executed by the attached coprocessor 1645. Accordingly, the processor 1610 issues these coprocessor instructions (or control signals representing coprocessor instructions) on a coprocessor bus or other interconnect, to coprocessor 1645. Coprocessor(s) 1645 accept and execute the received coprocessor instructions.

Referring now to FIG. 17, shown is a block diagram of a first more specific example system 1700 in accordance with an embodiment. As shown in FIG. 17, multiprocessor system 1700 is a point-to-point interconnect system, and includes a first processor 1770 and a second processor 1780 coupled via a point-to-point interconnect 1750. Each of processors 1770 and 1780 may be some version of the processor 1500. In an embodiment, processors 1770 and 1780 are respectively processors 1610 and 1615, while coprocessor 1738 is coprocessor 1645. In another embodiment, processors 1770 and 1780 are respectively processor 1610 coprocessor 1645.

Processors 1770 and 1780 are shown including integrated memory controller (IMC) units 1772 and 1782, respectively. Processor 1770 also includes as part of its bus controller units point-to-point (P-P) interfaces 1776 and 1778; similarly, second processor 1780 includes P-P interfaces 1786 and 1788. Processors 1770, 1780 may exchange information via a point-to-point (P-P) interface 1750 using P-P interface circuits 1778, 1788. As shown in FIG. 17, IMCs 1772 and 1782 couple the processors to respective memories, namely a memory 1732 and a memory 1734, which may be portions of main memory locally attached to the respective processors.

Processors 1770, 1780 may each exchange information with a chipset 1790 via individual P-P interfaces 1752, 1754 using point to point interface circuits 1776, 1794, 1786, 1798. Chipset 1790 may optionally exchange information with the coprocessor 1738 via a high-performance interface 1739. In one embodiment, the coprocessor 1738 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1790 may be coupled to a first bus 1716 via an interface 1796. In one embodiment, first bus 1716 may be a Peripheral Component Interconnect (PCI) bus, or a bus such as a PCI Express bus or another third generation 1/0 interconnect bus, although the scope of the present techniques and configurations is not so limited.

As shown in FIG. 17, various I/O devices 1714 may be coupled to first bus 1716, along with a bus bridge 1718 which couples first bus 1716 to a second bus 1720. In one embodiment, one or more additional processor(s) 1715, such as coprocessors, high-throughput MIC processors, GPGPU's, accelerators (such as, e.g., graphics accelerators or digital signal processing (DSP) units), field programmable gate arrays, or any other processor, are coupled to first bus 1716. In one embodiment, second bus 1720 may be a low pin count (LPC) bus. Various devices may be coupled to a second bus 1720 including, fir example, a keyboard and/or mouse 1722, communication devices 1727 and a storage unit 1728 such as a disk drive or other mass storage device which may include instructions/code and data 1730, in one embodiment. Further, an audio I/O 1724 may be coupled to the second bus 1720. Note that other architectures are possible. For example, instead of the point-to-point architecture of FIG. 17, system may implement a multi-drop bus or other such architecture.

Referring now to FIG. 18, shown is a block diagram of a second more specific example system 1800 in accordance with an embodiment. Like elements in FIGS. 17 and 18 bear like reference numerals, and certain aspects of FIG. 17 have been omitted from FIG. 18 in order to avoid obscuring other aspects of FIG. 18.

FIG. 18 illustrates that the processors 1770, 1780 may include integrated memory and I/O control logic (“CL”) 1772 and 1782, respectively. Thus, the CL 1772, 1782 include integrated memory controller units and include I/O control logic. FIG. 18 illustrates that not only are the memories 1732, 1734 coupled to the CL 1772, 1782, but also that I/O devices 1814 are also coupled to the control logic 1772, 1782. Legacy 110 devices 1815 are coupled to the chipset 1790.

Referring now to FIG. 19, shown block diagram of a SoC 1900 in accordance with an embodiment. Similar elements in FIG. 18 bear like reference numerals. Also, dashed lined boxes are optional features on more advanced SoCs. In FIG. 19, an interconnect unit(s) 1902 is coupled to: an application processor 1910 which includes a set of one or more cores 1502A-N, cache units 1504A-N, and shared cache unit(s) 1506; a system agent unit 1510; a bus controller unit(s) 1516; an integrated memory controller unit(s) 1514; a set or one or more coprocessors 1920 which may include integrated graphics logic, an image processor, an audio processor, and a video processor; an static random access memory (SRAM) unit 1930; a direct memory access (DMA) unit 1932; and a display unit 1940 for coupling to one or more external displays. In one embodiment, the coprocessor(s) 1920 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments may be implemented as computer programs or program code executing on programmable systems comprising at least one processor, a storage system (including volatile and non-volatile memory and/or storage elements), at least one input device, and at least one output device.

Program code, such as code 1730 illustrated in FIG. 17, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 20 is a block diagram contrasting the use of a software instruction converter to convert binary instructions in a source instruction set to binary instructions in a target instruction set according to various embodiments. In the illustrated embodiment, the instruction converter is a software instruction converter, although alternatively the instruction converter may be implemented in software, firmware, hardware, or various combinations thereof. FIG. 20 shows a program in a high level language 2002 may be compiled using an x86 compiler 2004 to generate x86 binary code 2006 that may be natively executed by a processor with at least one x86 instruction set core 2016. The processor with at least one x86 instruction set core 2016 represents any processor that may perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 2004 represents a compiler that is operable to generate x86 binary code 2006 (e.g., object code) that may, with or without additional linkage processing, be executed on the processor with at least one x86 instruction set core 2016. Similarly, FIG. 20 shows the program in the high level language 2002 may be compiled using an alternative instruction set compiler 2008 to generate alternative instruction set binary code 2010 that may be natively executed by a processor without at least one x86 instruction set core 2014 (e.g., a processor with cores that execute the MIPS instruction set of MIPS Technologies of Sunnyvale, Calif. and/or that execute the ARM instruction set of ARM Holdings of Sunnyvale, Calif.). The instruction converter 2012 is used to convert the x86 binary code 2006 into code that may be natively executed by the processor without an x86 instruction set core 2014. This converted code is not likely to be the same as the alternative instruction set binary code 2010 because an instruction converter capable of this is difficult to make; however, the converted code will accomplish the general operation and be made up of instructions from the alternative instruction set. Thus, the instruction converter 2012 represents software, firmware, hardware, or a combination thereof that, through emulation, simulation or any other process, allows a processor or other electronic device that does not have an x86 instruction set processor or core to execute the x86 binary code 2006.

### ADDITIONAL NOTES & EXAMPLES

Example 1 is a system for procedural neural network synaptic connection modes, the system comprising: an axon processor to: receive a spike indication; and load a synapse list header based on the spike indication; and spike target generator circuitry to execute a generator function to produce the spike message, wherein the generator function is identified in the synapse list header, the generator function accepting a current synapse value as input.

In Example 2, the subject matter of Example 1 includes, wherein the axon processor is to communicate a spike message to a neuron.

In Example 3, the subject matter of Examples 1-2 includes, wherein the generator function is stored in the synapse list header.

In Example 4, the subject matter of Examples 1-3 includes, wherein the synapse list header includes an identifier for the generator function, the generator function being external to the synapse list header.

In Example 5, the subject matter of Examples 1-4 includes, wherein the current synapse value is a numerical value at an increment corresponding to a position of a current synapse in relation to other synapses in a synapse list that corresponds to the synapse list header.

In Example 6, the subject matter of Example 5 includes, wherein the synapse list is a fan-out synapse list corresponding to a second neuron originating the spike indication.

In Example 7, the subject matter of Example 6 includes, wherein the synapse list is a fan-in synapse list corresponding to the neuron.

In Example 8, the subject matter of Examples 1-7 includes, wherein the generator function implements a spatial connection mode.

In Example 9, the subject matter of Example 8 includes, wherein the generator function implements an all-to-all spatial connection mode.

In Example 10, the subject matter of Example 9 includes, wherein, to execute the generator function to produce the spike message, the spike target generator circuitry is to: locate a beginning of a contiguous list of synapse weights using the current synapse value; assign an increment to each element of the contiguous list of synapse weights; and derive a neuron identifier for each destination neuron via the increment to each element of the contiguous list of synapse weights.

In Example 11, the subject matter of Examples 8-10 includes, wherein the generator function implements a sparse connection mode.

In Example 12, the subject matter of Example 11 includes, wherein, to execute the generator function to produce the spike message, the spike target generator circuitry is to: compute indices into a contiguous list of synapse weights using the current synapse value; and derive a respective neuron identifier for each member of the indices.

In Example 13, the subject matter of Example 12 includes, wherein, to compute the set of indices, the spike target generator circuitry is to hash the current synapse value to produce the set of indices.

In Example 14, the subject matter of Example 13 includes, wherein the hash is selected from a list of hashes based on a target connectivity density.

In Example 15, the subject matter of Examples 8-14 includes, wherein the generator function implements a tiled connection mode.

In Example 16, the subject matter of Example 15 includes, wherein, to execute the generator function to produce the spike message, the spike target generator circuitry is to: combine the current synapse value with modifiers to produce destination addresses; and derive a respective neuron identifier for the destination addresses.

In Example 17, the subject matter of Examples 1-16 includes, wherein, to execute the generator function to produce the spike message, the spike target generator circuitry is to generate a temporal element of the spike message.

In Example 18, the subject matter of Example 17 includes, wherein the temporal element is arbitrary and is generated by a determinative function with the current synapse value as a parameter and a random distribution of outputs across all possible synapse value parameters.

In Example 19, the subject matter of Examples 17-18 includes, wherein the temporal element is fixed and is generated by assigning the same delay without regard to the current synapse value.

In Example 20, the subject matter of Examples 17-19 includes, wherein the temporal element is a uniform distribution and is generated by a determinative function with the current synapse value as a parameter and a uniform distribution of outputs across all possible synapse value parameters.

In Example 21, the subject matter of Examples 1-20 includes, wherein, to execute the generator function to produce the spike message, the spike target generator circuitry is to generate a weight element of the spike message.

In Example 22, the subject matter of Examples 1-21 includes, wherein the spike target generator circuitry is packaged with the axon processor.

In Example 23, the subject matter of Example 22 includes, wherein the system includes neural processor clusters connected via an interconnect to the axon processor.

In Example 24, the subject matter of Example 23 includes, wherein the system includes a power supply to provide power to components of the system, the power supply including an interface to provide power via mains power or a battery.

Example 25 is a method for procedural neural network synaptic connection modes, the method comprising: receiving a spike indication; loading a synapse list header based on the spike indication; executing, by spike target generator circuitry, a generator function to produce a spike message, wherein the generator function is identified in the synapse list header, the generator function accepting a current synapse value as input; and communicating the spike message to a neuron.

In Example 26, the subject matter of Example 25 includes, wherein the generator function is stored in the synapse list header.

In Example 27, the subject matter of Examples 25-26 includes, wherein the synapse list header includes an identifier for the generator function, the generator function being external to the synapse list header.

In Example 28, the subject matter of Examples 25-27 includes, wherein the current synapse value is a numerical value at an increment corresponding to a position of a current synapse in relation to other synapses in a synapse list that corresponds to the synapse list header.

In Example 29, the subject matter of Example 28 includes, wherein the synapse list is a fan-out synapse list corresponding to a second neuron originating the spike indication.

In Example 30, the subject matter of Example 29 includes, wherein the synapse list is a fan-in synapse list corresponding to the neuron.

In Example 31, the subject matter of Examples 25-30 includes, wherein the generator function implements a spatial connection mode.

In Example 32, the subject matter of Example 31 includes, wherein the generator function implements an all-to-all spatial connection mode.

In Example 33, the subject matter of Example 32 includes, wherein executing the generator function to produce the spike message includes: locating a beginning of a contiguous list of synapse weights using the current synapse value; assigning an increment to each element of the contiguous list of synapse weights; and deriving a neuron identifier for each destination neuron via the increment to each element of the contiguous list of synapse weights.

In Example 34, the subject matter of Examples 31-33 includes, wherein the generator function implements a sparse connection mode.

In Example 35, the subject matter of Example 34 includes, wherein executing the generator function to produce the spike message includes: computing indices into a contiguous list of synapse weights using the current synapse value; and deriving a respective neuron identifier for each member of the indices.

In Example 36, the subject matter of Example 35 includes, wherein computing the set of indices includes hashing the current synapse value to produce the set of indices.

In Example 37, the subject matter of Example 36 includes, wherein the hashing is performed with a hash selected from a list of hashes based on a target connectivity density.

In Example 38, the subject matter of Examples 31-37 includes, wherein the generator function implements a tiled connection mode.

In Example 39, the subject matter of Example 38 includes, wherein, executing the generator function to produce the spike message includes: combining the current synapse value with modifiers to produce destination addresses; and deriving a respective neuron identifier for the destination addresses.

In Example 40, the subject matter of Examples 25-39 includes, wherein executing a generator function identified in the synapse list header to produce a spike message includes generating a temporal element of the spike message.

In Example 41, the subject matter of Example 40 includes, wherein the temporal element is arbitrary and is generated by a determinative function with the current synapse value as a parameter and a random distribution of outputs across all possible synapse value parameters.

In Example 42, the subject matter of Examples 40-41 includes, wherein the temporal element is fixed and is generated by assigning the same delay without regard to the current synapse value.

In Example 43, the subject matter of Examples 40-42 includes, wherein the temporal element is a uniform distribution and is generated by a determinative function with the current synapse value as a parameter and a uniform distribution of outputs across all possible synapse value parameters.

In Example 44, the subject matter of Examples 25-43 includes, wherein executing a generator function identified in the synapse list header to produce a spike message includes generating a weight element of the spike message.

In Example 45, the subject matter of Examples 25-44 includes, wherein the spike target generator circuitry is packaged with an axon processor.

In Example 46, the subject matter of Example 45 includes, wherein the axon processor is part of a system that includes neural processor clusters connected via an interconnect to the axon processor.

In Example 47, the subject matter of Example 46 includes, wherein the system includes a power supply to provide power to components of the system, the power supply including an interface to provide power via mains power or a battery.

Example 48 is at least one machine readable medium including instructions to implement procedural neural network synaptic connection modes, the instructions, when executed by processing circuitry, cause the processing circuitry to perform operations comprising: receiving a spike indication; loading a synapse list header based on the spike indication; executing a generator function to produce a spike message, wherein the generator function is identified in the synapse list header, the generator function accepting a current synapse value as input; and communicating the spike message to a neuron.

In Example 49, the subject matter of Example 48 includes, wherein the generator function is stored in the synapse list header.

In Example 50, the subject matter of Examples 48-49 includes, wherein the synapse list header includes an identifier for the generator function, the generator function being external to the synapse list header.

In Example 51, the subject matter of Examples 48-50 includes, wherein the current synapse value is a numerical value at an increment corresponding to a position of a current synapse in relation to other synapses in a synapse list that corresponds to the synapse list header.

In Example 52, the subject matter of Example 51 includes, wherein the synapse list is a fan-out synapse list corresponding to a second neuron originating the spike indication.

In Example 53, the subject matter of Example 52 includes, wherein the synapse list is a fan-in synapse list corresponding to the neuron.

In Example 54, the subject matter of Examples 48-53 includes, wherein the generator function implements a spatial connection mode.

In Example 55, the subject matter of Example 54 includes, wherein the generator function implements an all-to-all spatial connection mode.

In Example 56, the subject matter of Example 55 includes, wherein executing the generator function to produce the spike message includes: locating a beginning of a contiguous list of synapse weights using the current synapse value; assigning an increment to each element of the contiguous list of synapse weights; and deriving a neuron identifier for each destination neuron via the increment to each element of the contiguous list of synapse weights.

In Example 57, the subject matter of Examples 54-56 includes, wherein the generator function implements a sparse connection mode.

In Example 58, the subject matter of Example 57 includes, wherein executing the generator function to produce the spike message includes: computing indices into a contiguous list of synapse weights using the current synapse value; and deriving a respective neuron identifier for each member of the indices.

In Example 59, the subject matter of Example 58 includes, wherein computing the set of indices includes hashing the current synapse value to produce the set of indices.

In Example 60, the subject matter of Example 59 includes, wherein the hashing is performed with a hash selected from a list of hashes based on a target connectivity density.

In Example 61, the subject matter of Examples 54-60 includes, wherein the generator function implements a tiled connection mode.

In Example 62, the subject matter of Example 61 includes, wherein, executing the generator function to produce the spike message includes: combining the current synapse value with modifiers to produce destination addresses; and deriving a respective neuron identifier for the destination addresses.

In Example 63, the subject matter of Examples 48-62 includes, wherein executing a generator function identified in the synapse list header to produce a spike message includes generating a temporal element of the spike message.

In Example 64, the subject matter of Example 63 includes, wherein the temporal element is arbitrary and is generated by a determinative function with the current synapse value as a parameter and a random distribution of outputs across all possible synapse value parameters.

In Example 65, the subject matter of Examples 63-64 includes, wherein the temporal element is fixed and is generated by assigning the same delay without regard to the current synapse value.

In Example 66, the subject matter of Examples 63-65 includes, wherein the temporal element is a uniform distribution and is generated by a determinative function with the current synapse value as a parameter and a uniform distribution of outputs across all possible synapse value parameters.

In Example 67, the subject matter of Examples 48-66 includes, wherein executing a generator function identified in the synapse list header to produce a spike message includes generating a weight element of the spike message.

Example 68 is a system for procedural neural network synaptic connection modes, the system comprising: means for receiving a spike indication; means for loading a synapse list header based on the spike indication; means for executing a generator function to produce a spike message, wherein the generator function is identified in the synapse list header, the generator function accepting a current synapse value as input; and means for communicating the spike message to a neuron.

In Example 69, the subject matter of Example 68 includes, wherein the generator function is stored in the synapse list header.

In Example 70, the subject matter of Examples 68-69 includes, wherein the synapse list header includes an identifier for the generator function, the generator function being external to the synapse list header.

In Example 71, the subject matter of Examples 68-70 includes, wherein the current synapse value is a numerical value at an increment corresponding to a position of a current synapse in relation to other synapses in a synapse list that corresponds to the synapse list header.

In Example 72, the subject matter of Example 71 includes, wherein the synapse list is a fan-out synapse list corresponding to a second neuron originating the spike indication.

In Example 73, the subject matter of Example 72 includes, wherein the synapse list is a fan-in synapse list corresponding to the neuron.

In Example 74, the subject matter of Examples 68-73 includes, wherein the generator function implements a spatial connection mode.

In Example 75, the subject matter of Example 74 includes, wherein the generator function implements an all-to-all spatial connection mode.

In Example 76, the subject matter of Example 75 includes, wherein the means for executing the generator function to produce the spike message include: means for locating a beginning of a contiguous list of synapse weights using the current synapse value; means for assigning an increment to each element of the contiguous list of synapse weights; and means for deriving a neuron identifier for each destination neuron via the increment to each element of the contiguous list of synapse weights.

In Example 77, the subject matter of Examples 74-76 includes, wherein the generator function implements a sparse connection mode.

In Example 78, the subject matter of Example 77 includes, wherein the means for executing the generator function to produce the spike message include: means for computing indices into a contiguous list of synapse weights using the current synapse value; and means for deriving a respective neuron identifier for each member of the indices.

In Example 79, the subject matter of Example 78 includes, wherein the means for computing the set of indices include means for hashing the current synapse value to produce the set of indices.

In Example 80, the subject matter of Example 79 includes, wherein the hashing is performed with a hash selected from a list of hashes based on a target connectivity density.

In Example 81, the subject matter of Examples 74-80 includes, wherein the generator function implements a tiled connection mode.

In Example 82, the subject matter of Example 81 includes, wherein the means for executing the generator function to produce the spike message include: means for combining the current synapse value with modifiers to produce destination addresses; and means for deriving a respective neuron identifier for the destination addresses.

In Example 83, the subject matter of Examples 68-82 includes, wherein the means for executing a generator function identified in the synapse list header to produce a spike message include means for generating a temporal element of the spike message.

In Example 84, the subject matter of Example 83 includes, wherein the temporal element is arbitrary and is generated by a determinative function with the current synapse value as a parameter and a random distribution of outputs across all possible synapse value parameters.

In Example 85, the subject matter of Examples 83-84 includes, wherein the temporal element is fixed and is generated by assigning the same delay without regard to the current synapse value.

In Example 86, the subject matter of Examples 83-85 includes, wherein the temporal element is a uniform distribution and is generated by a determinative function with the current synapse value as a parameter and a uniform distribution of outputs across all possible synapse value parameters.

In Example 87, the subject matter of Examples 68-86 includes, wherein the means for executing a generator function identified in the synapse list header to produce a spike message include means for generating a weight element of the spike message.

Example 88 is at least one machine-readable medium including instructions that, when executed by processing circuitry, cause the processing circuitry to perform operations to implement of any of Examples 1-87.

Example 89 is an apparatus comprising means to implement of any of Examples 1-87.

Example 90 is a system to implement any of Examples 1-87.

Example 91 is a method to implement of any of Examples 1-87.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A system for procedural neural network synaptic connection modes, the system comprising:
an axon processor to:
receive a spike indication; and
load a synapse list header based on the spike indication; and
spike target generator circuitry to execute a generator function to produce the spike message, wherein the generator function is identified in the synapse list header, the generator function accepting a current synapse value as input.

2. The system of claim 1, wherein the axon processor is to communicate a spike message to a neuron.

3. The system of claim 1, wherein the current synapse value is a numerical value at an increment corresponding to a position of a current synapse in relation to other synapses in a synapse list that corresponds to the synapse list header.

4. The system of claim 1, wherein the generator function implements a spatial connection mode.

5. The system of claim 4, wherein the generator function implements an all-to-all spatial connection mode.

6. The system of claim 4, wherein the generator function implements a sparse connection mode.

7. The system of claim 4, wherein the generator function implements a tiled connection mode.

8. The system of claim 1, wherein, to execute the generator function to produce the spike message, the spike target generator circuitry is to generate a temporal element of the spike message.

9. The system of claim 8, wherein the temporal element is arbitrary and is generated by a determinative function with the current synapse value as a parameter and a random distribution of outputs across all possible synapse value parameters.

10. The system of claim 1, wherein, to execute the generator function to produce the spike message, the spike target generator circuitry is to generate a weight element of the spike message.

11. The system of claim 1, wherein the spike target generator circuitry is packaged with the axon processor.

12. The system of claim 11, wherein the system includes neural processor clusters connected via an interconnect to the axon processor.

13. The system of claim 12, wherein the system includes a power supply to provide power to components of the system, the power supply including an interface to provide power via mains power or a battery.

14. A method for procedural neural network synaptic connection modes, the method comprising:
receiving a spike indication;
loading a synapse list header based on the spike indication;
executing, by spike target generator circuitry, a generator function to produce a spike message, wherein the generator function is identified in the synapse list header, the generator function accepting a current synapse value as input; and
communicating the spike message to a neuron.

15. The method of claim 14, wherein the generator function implements a spatial connection mode.

16. The method of claim 14, wherein executing a generator function identified in the synapse list header to produce a spike message includes generating a temporal element of the spike message.

17. At least one machine readable medium including instructions to implement procedural neural network synaptic connection modes, the instructions, when executed by processing circuitry, cause the processing circuitry to perform operations comprising:
receiving a spike indication;
loading a synapse list header based on the spike indication;
executing a generator function to produce a spike message, wherein the generator function is identified in the synapse list header, the generator function accepting a current synapse value as input; and
communicating the spike message to a neuron.

18. The at least one machine readable medium of claim 17, wherein the current synapse value is a numerical value at an increment corresponding to a position of a current synapse in relation to other synapses in a synapse list that corresponds to the synapse list header.

19. The at least one machine readable medium of claim 17, wherein the generator function implements a spatial connection mode.

20. The at least one machine readable medium of claim 19, wherein the generator function implements an all-to-all spatial connection mode.

21. The at least one machine readable medium of claim 19, wherein the generator function implements a sparse connection mode.

22. The at least one machine readable medium of claim 19, wherein the generator function implements a tiled connection mode.

23. The at least one machine readable medium of claim 17, wherein executing a generator function identified in the synapse list header to produce a spike message includes generating a temporal element of the spike message.

24. The at least one machine readable medium of claim 23, wherein the temporal element is arbitrary and is generated by a determinative function with the current synapse value as a parameter and a random distribution of outputs across all possible synapse value parameters.

25. The at least one machine readable medium of claim 17, wherein executing a generator function identified in the synapse list header to produce a spike message includes generating a weight element of the spike message.
